(19) United States
(12) Patent Application Publication
(10) Pub. No.: US 2009/0081755 A1
(43) Pub. Date: Mar. 26, 2009

(54) FRAGRANT CONSUMER PRODUCTS COMPRISING OXIDIZING AGENTS

(75) Inventors: Peter Schmiedel, Duesseldorf (DE); Wolfgang Von Rybinski, Duesseldorf (DE); Andreas Bauer, Kaarst (DE); Soeren Hoelsken, Duesseldorf (DE)

Correspondence Address: CONNOLLY BOVE LODGE & HUTZ LLP, PO BOX 2207, WILMINGTON, DE, 19899-2207, US

(73) Assignee: HENKEL AG & Co. Kg A, Duesseldorf (DE)

(21) Appl. No.: 12/092,413

(22) PCT Filed: Sep. 30, 2006
(86) PCT No.: PCT/EP06/09883

§ 371 Date: Sep. 5, 2008

(30) Foreign Application Priority Data
Nov. 14, 2005 (DE) 10 2005 054 565.3

(51) Int. Cl. C11D 3/395

(52) U.S. Cl. 435/183; 252/186.42; 252/186.1

(57) ABSTRACT

Fragrant consumer products comprising oxidizing agents are described, which may be, for example, detergents or cleaners or, for example, also cosmetics. These consumer products comprise certain minimum amounts of fragrances of certain classes of substances. They are characterized by very good (storage) stability, both with regard to the fragrance of the product, and also with regard to the potency of the oxidizing agent.

The present invention concerns a consumer product comprising an oxidizing agent, comprising a fragrance composition comprising a certain minimum proportion of fragrances of certain classes of substances. The consumer products may, for example, be detergents or cleaners, or also cosmetics.

As a general rule, use of fragrances in typical consumer products such as detergents or cleaners serves two different purposes. One is that the products as such are made fragrant. The other is that the objects on which the products act are made fragrant. With detergents or cleaners as an example, the freshly cleaned surfaces or the freshly washed laundry are intended to be given the impression of a “freshly cleaned” odor that should last as long as possible. In addition, the inherent odor of the detergents and cleaners, which is sometimes quite strong, should be covered up.

For many consumers, finally, the fragrance of a consumer product, such as a detergent or cleaner, gives a welcome possibility for differentiation in view of a range of products that is continuously becoming more complex, as in the field of detergents and cleaners.

Therefore the consumer would usually like to purchase a product that not only works well, but also appeals to his esthetic perception, such as by the product itself or the objects treated with it releasing a pleasant odor. For example, the consumer expects that stains on textiles or on hard surfaces will be removed with an appropriate product and, furthermore, he also expects that the product, at least, but even better, the object treated, will have a pleasant odor. This consumer expectancy is so strong that, for instance, he even expects an appropriate odor from a cleaned object. If this odor is lacking (e.g., “citrus-fresh” for toilet cleaners), the consumer will actually doubt that the product is really effective.

Suitable perfuming of products presents a disadvantage, especially with respect to perfuming of inexpensive products manufactured on a large scale. That is not only because of the cost, but in part also, for instance, due to incompatibilities of ingredients with the sensitive fragrances. Such perfuming can be accomplished only very inadequately with respect to the odor quality of the perfumed product.

Perfuming or products with oxidizing ability presents a particular problem. In many such cases, perfuming is omitted entirely because perfuming of such products often results in substantial instabilities of the product, especially after storage, so that the odor of a perfumed product that originally smells good is negatively altered in a dramatic manner after a few weeks of storage, such that it is not just neutral but even repellent. Thus the product becomes unusable or unsalable because of the perfuming.

Given this situation, the objective of the present invention was to provide a possibility for reducing problems in perfuming of products with oxidizing ability.

This problem was solved by a consumer product comprising an oxidizing agent, preferably a detergent or cleaner or a cosmetic product comprising a composition of fragrances in which at least 50% by weight, preferably at least 60% by weight, advantageously at least 65% by weight, more advantageously at least 70% by weight, still more advantageously at least 75% by weight, again more advantageously at least 80% by weight, and particularly advantageously at least 85% by weight of the fragrances contained are selected from fragrances that can be assigned to at least one of the following classes of materials:
saturated alcohols, preferably primary, secondary and/or tertiary saturated, optionally branched or optionally cyclic alcohols
saturated esters, optionally branched or cyclic saturated esters
saturated ethers, optionally branched or cyclic saturated ethers
aromatics with saturated substituents, optionally with branched saturated substituents
nitriles, optionally with unsaturation conjugated with the nitrile group
saturated acetals, optionally branched or cyclic saturated acetals
saturated hemiacetals
   in which the statement of percent by weight is based on the total proportion fragrance

The consumer product according to the invention, whereby the terms “consumer product”, “product” and “agent” are used synonymously, is preferably a detergent or cleaner, or a cosmetic agent. The consumer product according to the invention can be used in the household, but can also be used for industrial and institutional or commercial purposes.

The detergent or cleaner is particularly a liquid detergent or cleaner, also in spray form, but solid detergents or cleaners, particularly in the forms of tablets, pieces or powders, are also preferred.

Particularly preferred agents in the framework of the invention are detergents and laundry care agents, preferably for cleaning, treatment and/or care of fibers or textile objects, thus textile detergents, textile care materials, textile treatment materials, textile post-treatment materials and conditioners of all types. They also include separate bleaching agents, such as spot-removing salts, liquid bleaches, and substances that increase washing power. They can be used both as detergent additives and for pretreatment. They include hygienic rinses, which are preferably added to the last rinse and which contain an antimicrobial agent or oxidants and preferably nonionic surfactants. They also include detergents for curtains as well as special detergents for white laundry.

The preferred detergents include, among others, washing agents for tableware, especially those for dishwashing machines and cleaners for hard surfaces. Especially preferred detergents, which also include care agents in the sense of this application are, for example, especially all-purpose detergents or special detergents such as preferably automobile care agents or detergents, oven cleaners, bathroom cleaners, lime-removal agents, facade cleaners, window cleaners, spot-removal agents, floor care agents, floor cleaners, glass-ceramic cooking area cleaners, (hand) dishwashing agents, oven cleaners or oven care agents, leather cleaners or leather care agents, metal polishing agents, furniture cleaners or furniture care agents, pipe cleaners, sanitary cleaners, shower agents, carpet cleaners or carpet care agents, bathroom cleaners, bathroom flushing cleaners to be hung in the toilet tanks or flush boxes, each in solid or liquid form, as noted above.

Rinsing agents for dishwashing machines in particular are among the most preferred cleaning agents.

The preferred cleaning agents also include, among others, toilet cleaners or WC cleaners, that is, products for cleaning WC bowls and urinals, offered for sale preferably as powders, tablets, moldings or liquids, preferably gels. Aside from oxidizing agents and fragrances as well as other usual ingredients such as preferably surfactants, they can preferably comprise organic acids (e.g., citric acid and/or lactic acid) or preferably sodium bisulfate, amidosulfuric acid or phosphoric acid to remove lime deposits or so-called urine stone. Flushing cleaners are used for hanging in the toilet tanks or flush boxes. They preferably provide small proportions of acids, surfactants, oxidizing agents and/or fragrances, thus slowing deposition of stains.

Typical components, particularly of a solid toilet cleaner, preferably a powder, can for instance be selected preferably from the following:
anionic surfactants, preferably 0-40% by weight, advantageously 0.1-30% by weight, especially 15-20% by weight
nonionic surfactants, preferably 0-10% by weight
organic acids or acid salts, preferably 3-50% by weight, preferably 5-10% by weight
inorganic acids or acid salts, preferably 3-95% by weight, especially 25-90% by weight
alkalies, preferably 0-10% by weight, especially up to 5% by weight
sodium bicarbonate, preferably 0-30% by weight
neutral salts, preferably 0-30% by weight
sodium carbonate, preferably 0-10% by weight
cellulose, preferably 0-5% by weight, especially 1-2% by weight
complexing agents, preferably 0-10% by weight, especially 0.1 to 5% by weight
colorants, preferably <1% by weight
fragrances, preferably 0.01-10% by weight
oxidizing agents, preferably 0.01-25% by weight, especially 0.1-20% by weight,
   with the percentage in each case based on the complete agent.

Typical components of a toilet cleaner, especially a liquid, can for instance be selected from the following
anionic surfactants, preferably 0-30% by weight, advantageously 0.1-20% by weight and particularly 1-10% by weight
nonionic surfactants, preferably 0-20% by weight, especially 1-10% by weight
organic acids or acid salts, preferably 0-50% by weight, advantageously 4-40% by weight, especially 3-30% by weight
inorganic acids or acid salts, preferably 0-5% by weight, especially 0-2% by weight
sodium bicarbonate, preferably 0-10% by weight
neutral salts, preferably 0-10% by weight
cellulose, preferably 0-5% by weight
colorant, preferably <1% by weight
fragrance, preferably 0.01-10% by weight, especially 0.05-5% by weight
thickener, such as xanthan, preferably 0-5% by weight
water, preferably 0-99% by weight
oxidizing agent, preferably 0.01-25% by weight, especially 0.1-20% by weight
   with the percentage in each case based on the complete agent.

Typical ingredients of a flush cleaner (solid) for hanging in the toilet tank or the flush tank can preferably be selected from the following:
surfactants, such as APG [alkyl polyglucoside], fatty alcohol ethoxylates, fatty alkyl sulfates, fatty alkyl ether sulfates, linear alkylbenzene-sulfonates alkane sulfonates, etc., preferably in proportions of 0-40% by weight, especially 15-30% by weight.
acids or acid salts, such as formic acid, acetic acid, citric acid, amidosulfonic acid, sodium bisulfate, coco fatty acids, etc., preferably in proportions of 0-20% by weight, especially 0.1-15% by weight.
complexing agents, such as sodium citrate or sodium phosphonate, preferably in proportions of 0-10% by weight, especially 0.1-5% by weight.
fillers, such as sodium sulfate, preferably in proportions of 0-60% by weight, especially 0.1-30% by weight
colorants, preferably <1% by weight
fragrance, preferably 0.01-10% by weight, especially 0.05-5% by weight
oxidizing agent, preferably 0.01-25% by weight, especially 0.1-20% by weight
   with the percentages by weight based on the total agent in each case.

Typical components of a flush cleaner (liquid) for hanging in the toilet bowl or the flush tank can preferably be selected from the following:
surfactants, such as APG, fatty alcohol ethoxylates, fatty alkyl sulfates, fatty alkyl ether sulfates, linear alkylbenzenesulfonates, alkane sulfonates etc., preferably in proportions of 0-30% by weight, especially 5-20% by weight.
acids or acid salts, such as formic acid, acetic acid, citric acid, amidosulfonic acid, sodium bisulfate, coco fatty acids etc., preferably in proportions of 0-10% by weight, especially 0.01-5% by weight.
complexing agents, such as sodium citrate or sodium phosphonate, preferably in proportions of 0-10% by weight, especially 0.1-5% by weight
water, solvent, preferably 0-99% by weight
colorant, preferably <1% by weight
fragrance, preferably 0.01-10% by weight
oxidizing agent, preferably 0.01-25% by weight, especially 0.1-20% by weight
   with the percentage in each case based on the complete agent.

The preferred detergents also include, among others, pipe cleaning agents or sewer cleaners. They are preferably strongly alkaline preparations, which usually serve to eliminate pipe stoppages due to organic materials, such as hair, fat, food residues, soap deposits, etc. Additives of Al or Zn powder can serve to generate H₂ gas with effervescent action. Potential ingredients, aside from oxidizing agents and fragrances, are preferably alkalies, alkaline salts and neutral salts. Forms marketed as powders also preferably contain sodium nitrate and sodium chloride. Pipe cleaning agents in liquid form can also preferably contain hypochlorite. There are also sewer cleaners based on enzymes. Acidic preparations are also possible. The oxidizing agent is preferably in proportions of 0.01 to 60% by weight, especially in proportions up to 40% by weight. Fragrances are preferably in proportions of 0.01-10% by weight, with the weight percentages in each case based on the complete agent.

The preferred cleaning agents also include the universal or all-purpose cleaners or all-cleaners. They are universally applicable cleaners for all the hard surfaces in a household or business, which can be wiped off wet or damp. As a rule they are neutral or weakly alkaline or weakly acidic products, especially liquid products. All-purpose cleaners or all-cleaners in particular can contain ingredients selected from the following:
surfactants [such as alkanesulfonates (SAS), alkylbenzenesulfonates (LAS), alkylpolyglucosides (APG), fatty alcohol polyglycol ether sulfates (FAES), fatty alcohol polyglycol ethers (FAE, FAEO)], preferably 0-25% by weight, especially 0.1-20% by weight.
builders [such as trisodium citrate, sodium salt of nitrilotriacetic acid, sodium phosphonate, pentasodium triphosphate, preferably 0-10% by weight, especially 0.1-5% by weight.
solvents and hydrotropes [such as ethanol, propylene glycol ethers, sodium toluenesulfonate or sodium cumenesulfonate], preferably 0-10% by weight, especially 0.1 to 5% by weight
colorants, preferably <1% by weight
fragrances, preferably 0.01-10% by weight, especially 0.05-5% by weight.
preservatives
oxidizing agents, preferably 0.01-30% by weight, especially 0.1-20% by weight.
acids, such as acetic acid, citric acid, or maleic acid, preferably 0.1-10% by weight, especially 0.1-5% by weight
in the case of all-purpose cleaners adjusted to be weakly alkaline, also alkalies, such as sodium hydroxide, or soda, preferably 0-5% by weight.
water, preferably 0-99% by weight
   with the percentages in each case based on the complete agent.

There are also special disinfectant all-purpose cleaners. Those also contain antimicrobially active ingredients (such as alcohols, quaternary ammonium compounds, amphoteric surfactants, or Triclosan) or increased proportions of oxidizing agents, e.g., preferably >1% by weight, with the weight percentage based on the complete agent.

The preferred cleaning agents also include the sanitary cleaners, among others. These are products for the bath and toilet. The alkaline sanitary cleaners are used preferably to remove greasy contamination, while the acidic sanitary cleaners are used primarily to remove lime deposits. Sanitary cleaners also have advantageously substantial disinfectant action, especially the strongly alkaline sanitary cleaners containing chlorine.

Ingredients of alkaline sanitary cleaners can in particular include components selected from the following:
anionic surfactants, preferably 0-10% by weight, especially 1-5% by weight
nonionic surfactants, preferably 0-5% by weight, especially 1-3% by weight
sodium hydroxide, preferably 0-10% by weight, especially 1-5% by weight
Oxidizing agents, such as sodium hypochlorite, calcium hypochlorite or hydrogen peroxide, preferably 0.01-10%, especially 1-5% by weight
fragrances, preferably 0.01-10% by weight, especially 0.05-5% by weight
water preferably 0-99% by weight
   with the percentages by weight in each case based on the complete agent. Acidic sanitary cleaners preferably contain no alkalies, but instead acids or acid salts, preferably in proportions of 0.01-30% by weight, with the percentages by weight in each case based on the complete agent.

The preferred cleaning agents also include oven cleaners or grill cleaners, which are advantageously marketed in the form of gels or foam sprays. These are generally used to remove burned-on or carbonized food residues. Oven cleaners are preferably adjusted to be strongly alkaline with, for instance, sodium hydroxide, sodium metasilicate, or 2-aminoethanol. They generally also contain preferably anionic and/or nonionic surfactants, preferably water-soluble solvents and preferably thickeners such as polycarboxylate or carboxymethylcellulose, as well as oxidizing agents and fragrances.

The preferred cleaning agents also include metal polishing agents. Those are cleaners for certain types of metal such as stainless steel or silver. Stainless steel cleaners preferably comprise not only acids (preferably up to 3% by weight of, for instance, citric acid or lactic acid), surfactants (especially up to 5% by weight of preferably nonionic and/or anionic surfactants), water, and also solvents (preferably up to 15% by weight) to remove dirt, as well as other materials such as thickeners and preservatives. Products for preferably shiny stainless steel surfaces also comprise very fine polishing agents. Silver polishes, again, are preferably adjusted to be acidic. They comprise preferably complexing agents (such as thiourea or sodium thiosulfate) particularly to remove black coatings of silver sulfide. Typical forms marketed include polishing cloths, immersion baths, pastes, or liquids. Copper and bright metal cleaners (for brass and bronze, for instance) serve to remove dark discolorations (oxide layers). They are as a rule made weakly alkaline (with ammonia, preferably) and as a rule contain polishing agents and preferably also ammonium salts and/or as a rule contain polishing agents and preferably also ammonium soaps and/or complexing agents.

The preferred cleaning agents also include glass cleaners or window cleaners. They preferably serve to remove in particular fatty dirt from glass surfaces. They preferably comprise substances which can be advantageously selected from the following:
anionic and/or nonionic surfactants (especially up to 5% by weight)
ammonia and/or ethanolamine (especially up to 1% by weight)
ethanol and/or 2 propanol, glycol ethers (especially 10-30% by weight)
water
preservatives
colorants
fragrances
oxidizing agents
antitarnishing agents, etc.
   with the weight percentage in each case based on the complete agent.

The preferred cleaning agents also include all special cleanings agents, such as those for glass-ceramic cooking fields, carpet and cushion cleaners and spot removers.

Other products preferred according to the invention are auto care agents. The preferred auto care agents include, among others, paint preservatives, paint polishes, paint cleaners, washing preservatives, shampoos for washing automobiles, automobile washing and waxing products, polishing agents for ornamental metals, protective films for ornamental metals, plastic cleaners, tar removers, wheel cleaners, engine cleaners, etc.

The cleaners according to the invention can be used quite generally to clean surfaces such as glass, porcelain, plastic, textiles, leather, paints or wood.

The institutional or commercial cleaners, usually provided in large packages, are designed preferably for operational cleaning and hygiene in, for example, public buildings, schools, office buildings, hotels, guest-houses and hospitals. Such products are preferably made up so that preferably reliable surface disinfection can be assured. They can, for instance, contain high proportions of oxidizing agents, e.g., >1% by weight or >3% by weight or >5% by weight, with the weight percentage in each case based on the complete agent.

Industrial cleaners are generally used in industries, particularly in the beverage, metal, food, cosmetic and pharmaceutical industries, such as cleaners for vehicle washing plants, tank cars and aircraft cleaners.

In particular, industrial cleaners can be formulated advantageously with particularly low-foaming surfactants (e.g., special nonionic surfactants such as ethylene oxide—propylene oxide block copolymers and so-called end-group-blocked alkyl ethoxylates) to attain an optionally required productivity.

They can comprise high proportions of oxidizing agents, e.g, >1% by weight or >3% by weight or >5% by weight, with the weight percentage in each case based on the complete agent.

The cosmetic agents preferred according to the invention include in particular
(a) those for skin care, such as preferably bath reparations, hand washing and cleaning agents, skin care agents, eye cosmetics, lip care agents, nail care agents, intimate care agents, or foot care agents
(b) those with special action, such as preferably depigmentation agents, deodorants, antihydrotics, hair removal agents, depilants, fragrances
(c) those for oral and tooth care, such as preferably oral and tooth care agents, denture care agents, tooth prosthesis cleaning agents, tooth prosthesis adhesives
(d) those for hair care, such as preferably hair-washing agents, hair care agents, hair fixing agents, hair treatment agents, hair water, hair shaping agents, hair coloring agents, bleaches.

Preferred ingredients of consumer products according to the invention can be defined by their function. Of course, many ingredients are also multifunctional.

Preferred ingredients of consumer products according to the invention, preferably cosmetic products, can be selected from the following:
a) absorbers.
   They have the function of taking up water and/or soluble or finely divided substances
b) antimicrobial materials.
   They can be added to the products to reduce quite generally the activities of microorganisms, such as those on the skin and in the oral cavity.
c) antioxidants, preferably existing separately through special formulation of oxidizing agents.
   They are intended to serve to prevent reactions such as oxidation caused by oxygen and so to extent the useful life of the products, i.e., to provide quality for the products.
d) antiperspirants
   These are used preferably in cosmetics and prevent sweating.
e) antifoam agents
   These can be added, for example, to eliminate foam during production or to reduce the tendency of the finished products to foam excessively.
f) anti-scaling substances
   These are added primarily to hair care products because they can counteract scaling.
g) antistatics
   They aid combability in hair care products, for example. They generally reduce the electrostatic charge of objects, such as hair surfaces. With them, hair can be combed distinctly more easily.
h) binders
   They make sure that powdered and powder-containing products, such as cosmetic preparations, will hold together.
i) substances of biological origin
   Those are, for example, certain plant components such as green tea extract. They are intended to give a product certain desired properties related to the corresponding biological materials, or to further improve existing properties or to suppress undesired properties or reduce them as much as possible.
k) chelating agents
   These are, for instance, added to cosmetic agents to form complexes with metal ions, thus manipulating the stability and/or appearance of the agent, for instance.
l) deodorants/antiperspirants
   These can contribute to preventing or reducing occurrence of unpleasant body odor. They can cover up such odors and optionally reduce sweating.
m) emollients
   They have the function, in the cosmetic area, of making the skin smooth and supple.
n) emulsifiers
   These are surface-active substances which are preferably able to distribute immiscible liquids such as oil and water within each other.
o) emulsion stabilizers
   These can further support the process of emulsification (see Emulsifiers) and so further improve the stability and storability of the products.
p) depilatories
   These serve for preferably selective removal of body hair.
q) moisture donors
   These can contribute to maintaining or replacing skin moisture and prevent the skin drying out.
r) film formers
   These can, especially in cosmetic agents, produce a protective, stabilizing film on surfaces, especially of skin, hair or nails.
s) colorants
   These are also added to cosmetic products, for example, to produce product coloration or also to cause indirect object coloring, such as hair coloring.
t) preservatives
   These are added to cosmetic agents, for instance, to protect them from the injurious action of microorganisms (bacteria, molds, yeasts) and so to avoid spoilage.
u) anticorrosion agents
   These can, for example, serve to prevent corrosion of the packaging, for example, of a cosmetic agent, or to prevent corrosion of parts that otherwise come into contact with the agent.
v) solvents
   They can be, for example, the basis for liquid cosmetic products, for instance, as well as being used a component of solid products.
w) oral care materials
   They can provide for care of teeth and gums.
y) pH regulators/buffers
   These can, in cosmetics, for example, serve to establish or stabilize a desired pH.
z) reducing agents, preferably separated from oxidizing agents by a special formulation
   These can alter the chemical nature of another substance by redox processes.
aa) abrasives
   These can serve to remove material from various (body) surfaces, for instance, to support mechanical tooth cleaning or to improve the gloss of teeth.
bb) surfactants/substances with washing action
   These are compounds with interfacial activity, which serve for cleaning
cc) propellant gases
   These are gaseous substances by means of which products, such as cosmetic agents, can be put under pressure in pressure-resistant containers so that the contents are brought out by discharge of the pressure.
dd) opacifiers
   These can preferably be added to transparent or translucent products to make them opaque to visible light or near-light radiation.
ee) UV absorbers/light-filtering substances
   These can filter out certain UV radiations and so can protect the skin, for example, from premature aging due to light or from sunburn.
ff) denaturants
   These are added to cosmetic agents that contain ethanol, for example, to make them unpalatable.
gg) viscosity regulators
   These can increase or even reduce, the viscosity of a product.

The products according to the invention, preferably cosmetic agents, can contain the ingredients listed above according to some preferred embodiments.

Suitable formulations of products, especially of cosmetics but also of all others, for example, among others, also creams, pastes, tinctures, lotions, solutions, waters, emulsions such as W/O, O/W, and PIT emulsions (emulsions called PIT according to the phase inversion theory), microemulsions and multiple emulsions, coarse, unstable, single-phase or multi-phase mixtures to be shaken, gels, sprays, pouches, aerosols and foam aerosols.

The products according to the invention, such as preferably detergents or cleaning agents, are advantageously able, especially in comparison with agents that do not contain oxidizing agents, to provide improved capabilities, especially cleaning abilities, for example, with respect to removal of stains, especially colored stains. In addition they are advantageously able, especially in comparison with agents that do not contain oxidizing agents, to arrive at more effective hygienic powers for the materials to be treated (e.g., textiles, tableware, hard surfaces, etc.) by improved destruction of bacteria and other microorganisms, particularly with respect to a distinct reduction in the number of microorganisms. Furthermore, the fragrance composition according to the invention contributes to a pleasant smell for the entire agent, especially detergents or cleaning agents or cosmetics, thus improving their acceptance for the consumer.

A further advantage of the invention is that such a product is stable in storage, particularly with respect to the stability of the oxidizing agent and of the perfuming of the product. The fragrance impression of the perfumed material according to the invention advantageously does not change even on long storage for several weeks. Likewise, the activity of the oxidizing agent does not decrease significantly more, even on long storage for several weeks, than in the absence of the perfuming. Both apply advantageously also for liquid materials.

According to a preferred embodiment the fragrance composition contained in the agent according to the invention comprises at least 91% by weight, preferably at least 92% by weight, advantageously at least 94% by weight, more advantageously at least 96% by weight, still more advantageously at least 98% by weight, and further more advantageously at least 99% by weight, particularly even 100% by weight of such fragrances, which can be assigned to at least one of the following classes of material
saturated alcohols, preferably primary, secondary and/or tertiary saturated, optionally branched or optionally cyclic alcohols
saturated esters, optionally branched or cyclic saturated esters
saturated ethers, optionally branched or cyclic saturated ethers
aromatics with saturated substituents, optionally with branched saturated substituents
nitriles, optionally with unsaturation conjugated with the nitrile group
saturated acetals, optionally branched or cyclic saturated acetals
saturated hemiacetals
   in which the statement of percent by weight is based on the total proportion fragrance.

According to a further preferred embodiment, the fragrance composition contained in the agent according to the invention comprises at least 50% by weight, at least 60% by weight, at least 70% by weight, at least 80% by weight, at least 90% by weight or at least 91% by weight, preferably at least 92% by weight, advantageously at least 94% by weight, more advantageously at least 96% by weight, still more advantageously at least 98% by weight, further more advantageously at least 99% by weight, particularly even 100% by weight of fragrances selected from citronitril, ortho-tert.-butylcyclohexyl acetate, cyclohexyl salicylate, (−)-(1′R,3S,6′S)-1-(2′,2′,6′-trimethyl-1′-cyclohexyl)-3-hexanol, (−)-(1′S,3R,6′R)-1-(2′,2′,6′-trimethyl-1′-cyclohexyl)-3-hexanol, (+)-(1′R,3R,6′S)-1-(2′,2′,6′-trimethyl-1′-cyclohexyl)-3-hexanol, (−)-(1′S,3S,6′R)-1-(2′,2′,6′-trimethyl-1′-cyclohexyl)-3-hexanol, phenylethyl alcohol, 2-cyclohexylidene-2-phenylacetonitrile, decahydro-b-naphthyl acetate, cresyl acetate (para), methyl phenylacetate, allyl amyl glycolate, benzyl acetate, cyclohexylethyl acetate, ethyl-2-cyclohexyl propionate, phenylethyl acetate, cyclopentylideneacetic acid methyl ester [CAS No. 0040203-73-4], allyl (cyclohexyloxy)acetate, 2,4-dimethyl-1-3,dioxolane-2-acetic acid ethyl ester, 3,12-tridecadiene nitrile, amyl acetate, isoamyl acetate, ethyl phenylacetate, 2-propenylphenoxyacetate, isobornyl acetate, dimethylbenzylcarbinyl acetate, hexyl acetate, cresyl acetate (para), isobutylphenyl acetate, butylcyclohexyl acetate, cis-para-tert., butylcyclohexyl acetate, trans-para-tert., hydrocinnamyl alcohol, 2,6-dimethylheptane-2-ol, decanol, octanol, 2,6-dimethylbicyclo-[4.4.0]-decan-1-ol (0.1% in dipropylene glycol), tetrahydromuguol [=tetrahydrolinalool (3,7-dimethyloctan-3-ol)/tetrahydromyrcenol (2-octanol, 2,6-dimethyl) mixture (1:1), dihydroterpineol, alpha 3,3-trimethylcyclohexylmethyl formate, octanol-3, hexanol, 2,2,6-trimethyl-alpha-propylcyclohexanepropanol, decahydro-b-napththyl formate, (1′S,1″S,2′S,3″R,5″R)-[1-methyl-2-(1,2,2-trimethylbicyclo[3.1.0]-hex-3-ylmethyl)cyclopropyl]methanol, (1′R,1″R,2′R,3″S,5″S)-[1-methyl-2-(1,2,2-trimethylbicyclo[3.1.0]-hex-3-ylmethyl)cyclopropyl]methanol, (1′R,1″S,2′R,3″R,5″R)-[1-methyl-2-(1,2,2-trimethylbicyclo[3.1.0]-hex-3-ylmethyl)cyclopropyl]methanol, (1′S,1″R,2′S,3″S,5″S)-[1-methyl-2-(1,2,2-trimethylbicyclo[3.1.0]-hex-3-ylmethyl)cyclopropyl]methanol, borneol, dipropylene glycol, tetrahydrogeraniol, tetrahydrolinalool, 2,2,6-trimethyl-alpha-propylcyclohexanepropanol (Timberol forte), alpha-methyl-4-(1-methylethyl)cyclohexanemethanol, isocyclogeraniol, fenchyl alcohol, (−)-(2R,4S)-2-isobutyl-4-methyltetrahydro-2H-pyran-4-ol, (+)-(2S,4R)-2-isobutyl-4-methyltetrahydro-2H-pyran-4-ol, (+)-(2S,4S)-2-isobutyl-4-methyltetrahydro-2H-pyran-4-ol, (−)-(2R,4R)-2-isobutyl-4-methyltetrahydro-2H-pyran-4-ol, methyl benzoate, ethyl benzoate, methyl salicylate, amyl propionate, 2,6,6-trimethyl-1,3-cyclohexadiene-1-carboxylic acid ethyl ester, benzyl propionate, ethyl salicylate, 2-methoxy-4-formyl-phenyl isobutyrate (Isobutavan), ethyl caprylate, allyl caproate, 2-methyl-2-butenoic acid 2-methylpropyl ester, 2-ethyl ethylhexanoate (Irotyl), 2-methylpentanoic acid 2-methylpentyl ester, Jasmacyclate, 2,5-dimethyl-4,6-dihydroxybenzoic acid methyl ester, ethyl 2-methylvalerate, heptanoic acid 2-propenyl ester (allyl heptanoate-allyl enanthate), methyl anthranilate, phenylacetic acid, allylcyclohexyl propionate, 2-nonynic acid methyl ester, cyclohexyl salicylate, 2-tert.-butyl-cyclohexylethyl carbonate, 2,2,4-trimethylcaproic acid ethyl ester, ethyl ester Labdanum extract (Ambrarome), styryl acetate, hydroquinone dimethyl ether, diphenyl ether, cresyl methyl ether (para), cymene (para), phenylethylisoamyl ether, phenylethylmethyl ether, 4-isopropyl-5,5-dimethyl-1,3-dioxane, 2,2,5,5-tetramethyl-4-isopropyl-1,3-dioxane, 5-methyl-5-propyl-2-(1-methylbutyl)-1,3-dioxane, anethol, 2-phenyl-propionaldehyde dimethyl acetal, frambinone methyl ether, coumarin, isocoumarin, acetophenone, 1,1,2,3,3-pentamethyl-6,7-dihydro-4(5H)-indanone, octalactone gamma, ethyl amyl ketone, camphor synth., oxacyclo-heptadec-8-en-2-one 2-heptyl cyclopentanone, 2-(1-methylpropyl)-cyclohexanone, 4-tert.-butyl-2,6-dimethylacetophenone, cyclopentadecanolide, 3-methylcyclopentadecanone, dihydrojasmone, dihydro-iso-jasmone, decalactone gamma, methyl octalactone, 1,4-dioxacyclohexadecan-5,16-dione, 4-(2-butenyliden)-3,5,5-trimethyl-2-cyclohexen-1-one, ethyl 2,2,6-trimethylcyclohexanecarboxylate, cinnamic acid nitrile, lauric acid nitrile, hydrocitronitril, 2-benzyl-2-methyl-3-butenenitrile, 3-methyldodecanonitrile, citronitril, tridecen-2-nitrile, *3(4,7,7-trimethylbicyclo<4.1.0>hept-3-yl-2-propenyl nitrile, Irolene p, 8-alpha-12-oxido-13,14,15,16-tetranorlabdan, 3,35-trimethylcyclohexyl ethyl ether, Irival (70% 4-tert.-pentylcyclohexanone, 10% white mineral oil, 10% non-2-ene nitrile, 10% dibutyl sebacate), isobutyl quinoline, 5-ethylidenebicyclo[2.2.1]-2-hepten-2-methoxyphenol adduct, methylbutyl-2 propionate, indenol[1,2-d]-tetrahydro-1,3-dioxane, dodecahydro-3a,6,6,9a-tetramethylnaptho(2,1-b)-furan, 2,4-dimethyl-4-phenyltetrahydrofuran, spiro[1,3-dioxolane-2,5′-(4′,4′,8′,8′-tetramethylhexahydro-3′,9′-methanonaphthalene)], methyl dihydrojasmonate, methyl 3-oxo-2-pentylcyclopentane acetate, o-(allyloxy)anisole, dihydromyrcenol, 9-decen-1-ol, tetrahydromyrcenol, hexahydro-4,7-methanoinden-6-yl acetate, 2-phenoxyethyl isobutyrate, 2-methylpropenoic acid 1,3-dimethyl-3-butenyl ester, methylacetophenone para, 4-phenyl-2-butanone, 1-(5,5-dimethyl-1-cyclohexen-1-yl)-4-penten-1-one, 3-hydroxy-1-methyl-4-isopropyl benzene (CAS No.: 89-83-8), with the percentages by weight based on the total proportion of fragrance.

These fragrances listed above are usable with good success in the sense according to the invention, particularly in liquid agents.

Corresponding fragrance compositions assure extraordinary stability results, especially with respect to PAP, even with highly reactive oxidizing agents such as peroxycarboxylic acids, which can advantageously be selected from mono and di-peroxycarboxylic acids, especially dodecan-diperoxy-acid or preferably imidoperoxycarboxylic acids, especially preferably 6-phthalimido-peroxycaproic acid (6-phthalimidoperoxyhexanoic acid, PAP). The potency of the oxidizing agent is maintained very well even after long storage, advantageously also in liquid agents. The good smell of the fragrance composition is maintained very well even after long storage, advantageously also in liquid agents.

In a preferred embodiment, the product comprises certain minimal proportions of fragrances, that is, at least 0.01% by weight or 0.05% by weight, advantageously at least 0.1% by weight, in a substantially more advantageous manner at least 0.15% by weight, in a more advantageous manner at least 0.2% by weight, in a further more advantageous manner at least 0.25% by weight, in a still further more advantageous manner at least 0.3% by weight, in a very advantageous manner at least 0.35% by weight, in a particularly advantageous manner at least 0.4% by weight, in a quite specially more advantageous manner at least 0.45% by weight, in a substantially more advantageous manner at least 0.5% by weight, in a quite considerably more advantageous manner at least 0.55% by weight, in an extremely advantageous manner at least 0.6% by weight, in a maximally more advantageous manner at least 0.65% by weight, in an outstandingly more advantageous manner at least 0.7% by weight, in an exceptionally more advantageous manner at least 0.75% by weight, in an extraordinarily more advantageous manner at least 0.8% by weight, in an extraordinarily more advantageous manner at least 0.85% by weight, in particular at least 0.9% by weight of fragrances, based on the entire product.

In a preferred embodiment the product does indeed comprise higher proportions of fragrances, that is, at least 1% by weight, advantageously at least 2% by weight, in a considerably more advantageous manner at least 5% by weight, in a more advantageous manner at least 10% by weight, in a further more advantageous manner at least 13% by weight, on a still further more advantageous manner at least 14% by weight, in a very more advantageous manner at least 15% by weight, in a particularly more advantageous manner at least 16% by weight, in a quite particularly more advantageous manner at least 17% by weight, in a considerably more advantageous manner at least 18% by weight, in a quite considerably more advantageous manner at least 19% by weight, and especially at least 20% by weight fragrances, based on the complete product.

However, it is rather uncommon to have very high fragrance contents in consumer products to prevent the product having an overpowering smell. Instead, it is often desired that the proportion of fragrance contained be limited. In a preferred embodiment, therefore, the product comprises certain maximum proportions of perfume oil, namely, for example, not more than 30% by weight, 25% by weight, 20% by weight, or 15% by weight, advantageously not more than 10% by weight, in a considerably more advantageous manner not more than 9% by weight, in a more advantageous manner not more than 8% by weight, in a further more advantageous manner not more than 7% by weight, in a still further more advantageous manner not more than 6% by weight, in a very advantageous manner not more than 5% by weight, in particularly advantageous manner not more than 4.5% by weight, in a quite particularly more advantageous manner not more than 4% by weight, in a considerably more advantageous manner not more than 3.5% by weight, in particular not more than 3% by weight or 2% by weight of fragrances, based on the complete product. It must be noted here, for the entire text, that a statement of percent by weight always refers to the complete product unless something different is definitely stated or a different basis appears clearly from the definite context.

The general concept of an fragrance in the sense of the invention agrees with the usual definition. That is, it is normally a substance that is perceptible by its odor, especially a pleasant odor. These also include preferably aromatic substances. The fragrances currently used are especially ethereal oils, flower oils, extracts of vegetable and animal drugs, from natural products, isolated components (isolates), and semisynthetic and fully synthetic uniform fragrances.

All the conceivable oxidizing agents can be used as oxidizing agents, for instance perborates, percarbonates, hydrogen peroxide, sodium hypochlorite, dichromate, dithionite, permanganate, chlorine, concentrated sulfuric acid, organic peracids, chlorine, hypochlorite, chlorine dioxide, peroxides, etc. A series of bleaching agents that can be used advantageously is listed further below.

The oxidizing agents, preferably bleaches, can preferably be coated. The coating can serve to reduce interaction with other ingredients, but that is not completely successful.

According to a further preferred embodiment, the oxidizing agent is an oxidative bleaching agent, preferably based on an acid, with peroxycarboxylic acids particularly preferred.

According to a further preferred embodiment, the agent according to the invention comprises a peroxycarboxylic acid, selected advantageously from mono- and di-peroxycarboxylic acids, especially diperoxydodecanoic acid or preferably imidoperoxycarboxylic acids, especially preferably 6-phthalimidoperoxycaproic acid (6-phthalimidoperoxyhexanoic acid, PAP) and/or with the peroxycarboxylic acid having a melting point at atmospheric pressure above 25° C., particularly above 35° C., preferably above 45° C., preferably above 50° C., especially preferably above 100° C.

According to a further preferred embodiment, the oxidizing agent, especially the peroxycarboxylic acid, is present in essentially granular form, preferably coated, with the weight of the coating advantageously amounting to 0.1 to 30% by weight, based on the entire particles containing the oxidizing agent, preferably a granulate. Here “essentially” means that, preferably for a freshly produced product, advantageously at least 50, 55, 60, 65, 70, 75% by weight of the oxidizing agent is in granular form, with the statement of % by weight here based on the total proportion of oxidizing agent. In a liquid agent, for example, a portion of the oxidizing agent can be in dissolved form, especially after a storage period.

According to a preferred embodiment, the agent according to the invention comprises at least 0.01% by weight surfactant.

The surfactant content of the total agent can be, for example, 0.1-60% by weight, preferably 1-50% by weight, advantageously 5-45% by weight, still more advantageously 10-40% by weight, particularly 15-30% by weight, based on the complete agent. According to another preferred embodiment the lower limit of surfactant content can also be at a value of preferably 1% by weight, 2% by weight, 3% by weight, 4% by weight, 5% by weight, 6% by weight, 7% by weight, 8% by weight, 9% by weight, 10% by weight, 11% by weight, 12% by weight, 13% by weight, 14% by weight, 15% by weight, 16% by weight, 17% by weight, 18% by weight, 19% by weight 20% by weight, 21% by weight, 22% by weight, 23% by weight, 24% by weight, 25% by weight, 26% by weight, 27% by weight, 28% by weight, 29% by weight, or 30% by weight, based on the complete agent. The lower limit of the surfactant content can even be higher, e.g., at a value of preferably 35% by weight, 40% by weight, 45% by weight, 50% by weight, 55% by weight, or 60% by weight, based on the complete agent.

The upper limit of surfactant can for example also be at a value of preferably 65% by weight, 60% by weight, 55% by weight, 50% by weight, 45% by weight, 40% by weight, 35% by weight, 30% by weight or 25% by weight, or even at values of only 20% by weight, 19% by weight, 18% by weight, 17% by weight, 16% by weight, 15% by weight, 14% by weight, 13% by weight, 12% by weight, 11% by weight or 10% by weight. It is also possible for example, for example, to combine the statements above of upper and lower limits, for example, to state a surfactant content of 4-18% by weight. It is also possible that the agent contains 0% by weight surfactant.

Anionic surfactants, such as (linear) alkylbenzenesulfonates, fatty alcohol sulfates or alkanesulfonates, etc., are particularly preferred according to the invention, preferably in proportions of, for instance, 0.1 to 30% by weight, and/or nonionic surfactants, such as alkylpolyglycol ethers, alkylpolyglucosides or amine oxides, etc., preferably in proportions of, for instance, 0.1 to 30% by weight, based in each case on the complete agent.

The agent according to the invention can also contain cationic surfactants, for example, in proportions of 0.01% by weight or 0.05% by weight up to 50% by weight. There is a corresponding preferred embodiment, though, for the agent according to the invention to be free of cationic surfactants. Here, that means that the agent comprises less than 10% by weight, preferably less than 5% by weight, in an advantageous manner less than 3% by weight, in a more advantageous manner less than 1% by weight, in a still more advantageous manner less than 0.5% by weight, and particularly 0% by weight.

According to a preferred embodiment the agent according to the invention comprises electrolytes, especially inorganic and/or organic salts, particularly phosphate, citrate and/or sulfate, especially preferably sodium sulfate, preferably in proportions of at least 0.1% by weight, advantageously at least 3% by weight, particularly in proportions of 5 to 30% by weight, based in each case on the complete agent. It is also possible that the agent contains 0% by weight electrolyte.

If the agent according to the invention contains complexing agents, such as nitrilotriacetic acid, ethylenediaminetetraacetic acid or phosphonate, etc., preferably in proportions up to 30% by weight or up to 20% by weight, especially 0 to 10% by weight, advantageously 0.1 to 5% by weight, based on the complete agent, then there is a further preferred embodiment of the invention. Especially preferred are
(a) nitrogen-free complexing agents such as preferably alkali metal polyphosphonates, mono- or poly-phosphonic acids, especially 1-hydroxyethylidene-1,1-diphosphonic acid (HEDP), citrate and/or short-chain dicarboxylic acids and/or
(b) complexing agents from the group of quinoline and/or its salts, picolinic acid and dipicolinic acid (ethylenediaminetetraacetic acid (EDTA), diethylenetriaminepenta(methylenephosphonic acid) (DTPMP), azacycloheptane diphosphonate (AHP), nitrilotriacetic acid (NTA), aminopolycarboxylic acids, aminohydroxypolycarboxylic acids, polyphosphonic acids and aminopolyphosphonic acids. Here 1-hydroxyethylidene-1,1-diphosphonic acid is the most preferred. It is also possible that the agent contains 0% by weight of complexing agent.

The complexing agents can preferably be used according to the invention to inactivate or bind heavy metals which can act particularly as catalysts of oxidation processes and so can lead to degradation of the oxidizing agents, such as peroxycarboxylic acids such as PAP, which can be introduced, for example, through water lines or metallic parts in the production plants or through raw materials or ingredients in the agent according to the invention to inactivate or bind heavy metals which can act particularly as catalysts of oxidation processes and so can lead to degradation of the oxidizing agents, such as peroxycarboxylic acids such as PAP, which can be introduced, for example, through water lines or metallic parts in the production plants or through raw materials or ingredients in the agent according to the invention, such as detergents or cleaners.

According to a preferred embodiment of the invention, the agent according to the invention also contains enzymes, such as proteases, amylases, catalases, peroxidases, cellulases and/or lipases, and/or enzyme stabilizers, preferably in proportions of 0 to 10% by weight, based in each case on the complete agent. It is also possible that the agent contains 0% by weight enzyme.

According to a preferred embodiment the agent according to the invention contains builders. According to a further preferred embodiment of the invention, the builder content of the agent is for example 0-99% by weight, preferably 1-60% by weight, advantageously 2-50% by weight, still more advantageously 3-60% by weight, further advantageously 5-50% by weight, especially 6-40% by weight. According to another preferred embodiment, the lower limit of the builder content can also lie at a value of preferably 7% by weight, 8% by weight, 9% by weight, 10% by weight, 11% by weight, 12% by weight, 13% by weight, 14% by weight, 15% by weight, 16% by weight, 17% by weight, 18% by weight, 19% by weight, 20% by weight, 21% by weight, 22% by weight, 23% by weight, 24% by weight, 25% by weight, 26% by weight, 27% by weight, 28% by weight or 29% by weight or 30% by weight. The lower limit can even lie at higher values, for instance at a value of preferably 35% by weight, 40% by weight, 45% by weight, 50% by weight, 55% by weight, or 60% by weight.

According to a further preferred embodiment, the upper limit of the builder content can also lie at a value of preferably 70% by weight, 71% by weight, 72% by weight, 73% by weight, 74% by weight, 75% by weight, 76% by weight, 77% by weight, 78% by weight, 79% by weight, 80% by weight, 81% by weight, 82% by weight, 83% by weight, 84% by weight, 85% by weight, 86% by weight, 87% by weight, 88% by weight, 89% by weight, 90% by weight, 91% by weight, 92% by weight, 93% by weight, 94% by weight, or 95% by weight. The upper limit in particular can also lie at lower values, e.g., at a value of preferably 65% by weight 45% by weight, 35% by weight, 30% by weight, 25% by weight, 20% by weight, 15% by weight, 10% by weight, or 5% by weight. In the sense of another embodiment, it can also be possible that no builder, i.e., 0% by weight, is contained.

In the particular case of a liquid detergent, according to another preferred embodiment, there may be only a little builder contained, e.g., more than 0.1% by weight, more than 0.5% by weight or more than 1% by weight, but advantageously less than 30% by weight, preferably less than 20% by weight, especially less than 10% by weight.

According to another preferred embodiment the agent according to the invention contains fatty acids in particular as builders, preferably saturated and/or branched fatty acids, particularly having a melting point below 40° C., preferably below 30° C., and/or citric acid and/or citrate, preferably in proportions of, for example, 0 to 15% by weight, and/or polyacrylates, preferably in proportions of, for example, 0 to 15% by weight, and/or phosphonates, with the stated percentage by weight based on the complete agent in each case.

If the agent according to the invention has at least essentially no halide ions, particularly no chloride ions, with the proportion of halide ions, especially chloride ions advantageously not higher than 500 ppm, preferably not higher than 100 ppm, and particularly not higher than 30 ppm, then this is a preferred embodiment. As the applicant has learned, surprisingly, that a high concentration of halides, especially chloride ions, such as can commonly occur for example in the usual detergents and cleaners because of impurities in many raw materials or ingredients, can cause increased degradation of oxidizing agents, such as peroxycarboxylic acids, especially in liquid agents. Thus reduction of the halide concentration, especially of the chloride ion concentration, results in decreased degradation of the oxidizing agent, such as the peroxycarboxylic acids. According to the invention, a low chloride ion concentration can be achieved by use of methyl sulfate, phosphate, tosylate or cumenesulfonate compounds or by using low-chloride starting materials or ingredients (for example, use of essentially halide-free components, such as halide-free surfactants, halide-free phosphonates, etc.).

According to a further preferred embodiment, less than 30% by weight, preferably less than 20% by weight, advantageously less than 15% by weight, in a more advantageous manner less than 10% by weight, in a still more advantageous manner less than 5% by weight, in an again more advantageous manner less than 3% by weight, in a further advantageous manner less than 2% by weight, in a still further advantageous manner less than 1% by weight, in a particularly advantageous manner less than 0.5% by weight and particularly 0% by weight of the fragrances contained are selected from those fragrances having an aldehyde function (RCH═O) and/or a keto group (RR′C═O), with the statement of percent by weight in each case based on the total proportion of fragrance in the agent.

If the agent is in a liquid form, preferably in an aqueous or nonaqueous form, advantageously being a dispersion, preferably an emulsion or suspension, then there is a preferred embodiment. Here the agent can also be as a pouch.

By means of the invention, liquid detergents with outstanding washing power can be realized, particularly in the field of bleachable stains, combined with a very pleasant perfuming of both the product and the wash. The odor impression in the product is not subject to any change, even on long storage, and the perfuming exhibits no destabilizing action on the bleaching agents.

The agent, which is particularly in liquid form, according to a further preferred embodiment, shows a pH of advantageously not more than 7, in particular a pH of 3.5 to 7, preferably of 4.0 to 6.5, particularly preferably of 4.5 to 6, quite particularly preferably about 5, and/or, to the extent that this is a liquid agent, it can contain preferably at least one water-miscible solvent with a low ability to dissolve peroxycarboxylic acids, especially imidoperoxycarboxylic acids, preferably glycerin.

Bleaching agents, especially those based on peroxycarboxylic acids such as PAP, can be stabilized relatively effectively in an acidic environment, particularly at a pH of about 6. The potential reduction of the pH for a preferred embodiment, in the finished agent, preferably a liquid agent, especially liquid detergents and cleaners, can be accomplished, for example, by adding acids or acid salts. Bisulfates, bicarbonates and organic polycarboxylic acids, which can, for example, also be used as builders, are preferred according to the invention. Furthermore the phosphonates or citrates, which can be used as complexing agents, can be worked in as phosphonic acids or citric acid and then the desired pH can be adjusted by adding alkalies. It is also possible to add ionogenic surfactants, such as LAS, as the acids, in which case the pH can be adjusted by subsequent addition of sodium hydroxide.

The agents according to the invention, preferably (liquid) detergents or cleaners, can, according to a preferred embodiment, contain at least one fatty acid. Saturated and/or branched fatty acids are preferred according to the invention, especially those having a melting point less than 30° C. Within the present invention, Isocarb-16 from Sasol can, for instance, be used in the detergents or cleaners according to the invention.

The agents according to the invention, preferably (liquid) detergents or cleaners, can advantageously contain citric acid or citrate. Citric acid can, to be sure, lead to a degradation of peroxycarboxylic acids, particularly PAP. Nevertheless, it can optionally be advantageous to use citric acid or citrate in the agent according to the invention, the detergents or cleaners (for example, as builders and/or complexing agents).

The agents according to the invention can also be of gel-like or paste-like consistency. According to a preferred embodiment the agent is pourable, preferably having a viscosity between 100 and 10,000 mPas at a shear rate of 30 s⁻¹ and a temperature of 25° C.

According to another preferred embodiment the agent is in a solid form, preferably as a powder.

According to a preferred embodiment of the invention, the powder is made up mostly (i.e., in quantities of >50% by weight, >60% by weight, >70% by weight, >80% by weight, >90% by weight, or >95% by weight, based on the total powder) of homogeneous, preferably nearly spherical or ellipsoidal particles. An ellipsoid is similar to a sphere, but the longitudinal and transverse axes are different. However, the powder can also consist of embodiment forms other than particles, which are also mostly
(a) cubical (cube-shaped) or at least approximately cubical or
(b) of parallelepiped shape (e.g., cuboidal) or at least of approximately parallelepiped shape
(c) lamellar in shape (of plate-like form and the like) or at least approximately lamellar in shape or
(d) needle-like or fibrous, or at least approximately needle-like or fibrous or
(e) cylindrically shaped or
(f) stranded or at least approximately stranded.

According to another preferred embodiment of the invention, the agent according to the invention, if it is a solid agent, has a bulk density in the range of 200-1500 g/L. The lower limit of the bulk density can also lie at a value of preferably 250, 300, 350, 400, 450, 500, 550, 600, 650, 700 or even 750 g/L. It is also possible for the lower limit to be even higher, e.g., 800 g/L. The upper limit of the bulk density can lie at a value of preferably 1450, 1400, 1350, 1300, 1250, 1200, 1150, 1100, 1050, 1000, 900, 700, 850, 800 or 750 g/L. It is also possible for the upper limit to be even lower, for example, at a value of preferably 700, 650, 600, 550, or 500 g/L.

If the solid agent is a compaction, obtainable, for example, through processes such as pressing, rolling, briquetting, pelletizing, extruding, agglomerating or related compression processes, this is a further preferred embodiment.

According to a further preferred embodiment, the agent in solid form is a molding, preferably a tablet, or a block or a strand. Multiphase or multilayer moldings may be preferred. Solid pouches, that is, for example, powder in a pouch are also possible.

For the liquid agents, especially liquid detergents or cleaners, the content of inorganic salt, especially preferably sodium sulfate, in the dispersion (of the liquid agent) can be selected so that, at a temperature which is 5° C., particularly 10° C., preferably 15° C. lower than the storage or holding temperature of the dispersion (about 20° C.) there is essentially a dispersion, the aqueous phase of which is saturated with the inorganic salt. In this embodiment the content of inorganic salt, particularly preferably sodium sulfate, can be selected such that a dispersion saturated with the inorganic salt can be obtained at about 0° C. to 15° C., especially 0° C. to 10° C., preferably 0° C. to 5° C. Then the content of inorganic salt, particularly preferably sodium sulfate, in the dispersion can be 5 to 30% by weight, especially 10-30% by weight, preferably 15 to 30% by weight, based on the complete formulation.

Furthermore, according to a further preferred embodiment, the content of inorganic salt, especially preferably sodium sulfate, in the agent according to the invention, preferably a liquid agent, especially a liquid detergent or cleaner, can be selected so that the surfactants in the agent are at least essentially inactivated, particularly by salting out, i.e., inducing a phase separation into a low-surfactant continuous phase and a preferably lamellar, generally highly viscous crystalline or liquid crystalline surfactant-rich phase, preferably by introducing at least one sulfate compound, particularly preferably sodium sulfate. With such an embodiment, dissolution of the organic peroxycarboxylic acid is at least essentially prevented or at least reduced in the formulation, preferably a detergent or cleaner formulation. According to the invention, the concept of “continuous phase” is understood to mean the dispersing agent with the components or ingredients dissolved in it (e.g., salts, surfactants, etc.). Water is the preferred dispersing agent according to the invention.

By addition of sulfate, for example, according to a preferred embodiment, the surfactants—without wishing to fix on a theory—which can, where possible, lead to deactivation of the oxidizing agent, are at least partially inactivated. That can occur through salting out, in which the surfactants can be transformed from the particularly micellar active form into a preferably lamellar, crystalline or liquid crystalline form (formation of crystals or liquid crystals) which are dispersed in a nearly surfactant-free continuous phase. The dispersed liquid crystals themselves, which can be separated by centrifugation, for example, should be as highly viscous as possible. The content of free or active surfactants, i.e., those in micellar form in the liquid agents, preferably liquid detergent and cleaning formulations or in the continuous phase of the liquid detergent and cleaning formulations according to the invention can thus be very low according to a preferred embodiment, advantageously not more than 1%.

According to a preferred embodiment, the concentration of an inorganic salt, especially preferably sodium sulfate, in the agent according to the invention, especially a liquid detergent or cleaner, should be selected so that there is advantageously less than 1% dissolved surfactant in the continuous phase of the undiluted detergent or cleaner, and no crystallization of the salt, preferably sulfate, occurs, particularly on reduction of the temperature to 0° C.

As nonionic surfactants in particular can be problematic with respect to the stability of peroxycarboxylic acids in the agent according to the invention, preferably a liquid agent, especially a liquid detergent or cleaner, the agents according to the invention can preferably exhibit an appropriately adjusted or optimized surfactant ratio. Then the content of alkyl polyglycol ethers can preferably be as low as possible. In a preferred embodiment the content of nonionic surfactants actually goes to zero. Appropriate formulations can contain solely (linear) alkylbenzenesulfonates and/or (secondary) alkane sulfonates as surfactants, and can exhibit outstanding stability of the bleaching agent. According to a further preferred embodiment the product according to the invention, such as in particular detergent, care or cleaning agent, has at least one, preferably more, active components, especially detergent, care and/or cleaning-active components, selected advantageously from the group comprising anionic surfactants, cationic surfactants, amphoteric surfactants, nonionic surfactants, acidifying agents, alkalizing agents, anti-wrinkle agents, antibacterial substances, antioxidants, antiredeposition agents, antistatics, builders, bleaching agents, bleach activators, bleach stabilizers, bleach catalysts, ironing aids, cobuilders, anti-shrink agents, electrolytes, enzymes, color stabilizers, coloring agents, dyes, color transfer inhibitors, fluorescent agents, fungicides, germicides, odor-complexing substances, aids, hydrotropes, clear rinsing agents, complexing agents, preservatives, corrosion inhibitors, optical brighteners, perfume carriers, pearlescent materials, pH adjusters, phobing and impregnating agents, polymers, swelling and non-slip finishing agents, foam inhibitors, lamellar silicates, dirt repelling materials, antigraying agents, silicone oils, UV-protective substances, viscosity regulators, thickeners, discoloration inhibitors, graying inhibitors, vitamins and/or softening rinses. In a further preferred embodiment the agent according to the invention contains one or more skin-care and/or skin-protecting and/or skin-healing active substance.

Skin-care active substances are all those active substances that give the skin a sensory and/or cosmetic advantage. Skin-care active substances are preferably selected from the following substances:
a) waxes, such as carnauba, spermaceti, beeswax, lanolin and/or derivatives of those and others.
b) hydrophobic plant extracts c) hydrocarbons such as squalene and/or squalane
d) higher fatty acids, preferably those having at least 12 carbon atoms, such as lauric acid, stearic acid, behenic acid, myristic acid, palmitic acid, oleic acid, linoleic acid, isostearic acid and/or polyunsaturated fatty acids and others.
e) higher fatty alcohols, preferably those having at least 12 carbon atoms, such as lauryl alcohol, cetyl alcohol, stearyl alcohol, oleyl alcohol, behenyl alcohol, cholesterol and/or 2-hexadecaol and others
f) esters, preferably those such as cetyl octanoate, lauryl lactate, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactate, alkyl citrate and/or alkyl tartrate and others.
g) lipids such a cholesterol, ceramide and/or sucrose esters and others.
h) vitamins such as Vitamin A and E, vitamin alkyl esters, including Vitamin C alkyl esters and others.
i) sun screens
j) phospholipids
k) derivatives of alpha-hydroxy acids
l) fragrances
m) germicides for cosmetic use, as well as synthetics such as salicylic acid and/or others as well as natural such as neem oil and/or others.
n) silicones
o) and mixtures of any of the components listed above.

Preferred ingredients of the agents according to the invention will be described in more detail in the following. It is preferable for the products according to the invention to contain anionic surfactants. Anionic surfactants of the sulfonate and sulfate type are used, for example. Surfactants of the sulfonate type that come into consideration are preferably C₉₋₁₃-alkylbenzenesulfonates, olefin sulfonates, i.e., mixtures of alkene and hydroxyalkane sulfonates and disulfonates, such as one obtains from C₁₂₋₁₈ monoolefins with terminal or internal double bonds by sulfonation with gaseous sulfur trioxide and subsequent alkaline or acid hydrolysis of the sulfonation products. Alkane sulfonates such as are obtained from C₁₂₋₁₈ alkanes, for example, by sulfochlorination or sulfoxidation with subsequent hydrolysis or neutralization, are also suitable. The esters of α-sulfofatty acids (ester sulfonates), such as the α-sulfonated methyl esters of hydrogenated coco, palm kernel or tallow fatty acids, are also suitable.

Sulfonated fatty acid glycerol esters are also suitable anionic surfactants. The fatty acid glycerol esters are understood to be the mono-, di-, and tri-esters, or mixtures of them, such as are obtained by esterification of a monoglycerol with 1 to 3 moles of fatty acid, or by transesterification of triglycerides with 0.3 to 2 motes of glycerol. Preferred sulfonated fatty acid glycerol esters are sulfonation products of saturated fatty acids having 6 to 22 carbon atoms, such as caproic acid, caprylic acid, capric acid, myristic acid, lauric acid, palmitic acid, stearic acid or behenic acid.

Preferred alk(en)yl sulfates are the alkali and especially the sodium salts of sulfuric acid hemiesters of the C₁₂-C₁₈ fatty alcohols, such as coco fatty alcohol, tallow fatty alcohol, lauryl, myristyl, cetyl or stearyl alcohol, or of the C₁₀₋₂₀ oxoalcohols and the hemiesters of secondary alcohols having those chain lengths. Alk(en)yl sulfates of the specified chain lengths containing a straight-chain alkyl group produced synthetically or petrochemically, and which have degradative behavior similar to the adequate compounds based on fat-chemical raw materials. The C₁₂-C₁₅ alkyl sulfates, C₁₂-C₁₅ alkyl sulfates and the C₁₄-C₁₅ alkyl sulfates are also preferred are preferred from the viewpoint of laundering. The 2,3-alkyl sulfates, which can be obtained from Shell Oil Company as commercial products under the DAN® tradename, are also suitable anionic surfactants.

The sulfuric acid hemiesters of straight or branched C₇₋₂₁ alcohols that have been ethoxylated with 1 to 6 moles of ethylene oxide, such as 2-methyl branched C₉₋₁₁ alcohols having n average of 3.5 moles of ethylene oxide (EO) or C₁₂₋₁₈ fatty alcohols with 1 to 4 EO, are also suitable. They are used particularly in cleaners because of their high foaming power, preferably only in relatively low proportions, such as proportions of 1 to 5% by weight.

Another class of anionic surfactants is that of the ether carboxylic acids, accessible by reacting fatty alcohol ethoxylates with sodium chloroacetate in the presence of basic catalysts. They have the general formula: R¹⁰ O—(CH₂—CH₂—O), —CH₂—COOH, in which R¹⁰ is C₁-C₁₈ and p is 0.1 to 20. Ether carboxylic acids are not sensitive to hard water and exhibit outstanding surfactant properties.

The partial esters of di- or poly-hydroxyalkanes, mono- and di-saccharides, polyethylene glycols with the En adducts of maleic anhydride with at least singly unsaturated carboxylic acids having chain lengths of 10 to 25 carbon atoms, with an acid value of 10 to 140, are also examples of suitable anionic surfactants.

Preferred anionic surfactants have, aside from a branched or unbranched, saturated or unsaturated, aliphatic or aromatic, acyclic or cyclic, optionally alkoxylated alkyl group having 4 to 28, preferably 6 to 20, particularly 8 to 18, specially preferably 10 to 16, extremely preferably 12 to 14 carbon atoms, two or more anionic, especially two, acid groups, preferably carboxylate, sulfonate and/or sulfate groups, especially one carboxylate and one sulfate group. Examples of these compounds include α-sulfofatty acid salts, acyl glutamates, monoglyceride disulfates and alkyl ethers of glycerol disulfates and, in particular, the monoesterified sulfosuccinates described in the following.

The sulfosuccinates, sulfosuccinamates and sulfosuccinamides, especially sulfosuccinates and sulfosuccinamates, are especially preferred anionic surfactants, with sulfosuccinates being extremely preferred. The sulfosuccinates are salts of the mono- and di-esters of sulfosuccinic acid, HOOCCH(SO₃H)CH₂COOH, while the sulfosuccinamates are understood to be salts of the monoamides of sulfosuccinic acid and the sulfosuccinamides are understood to be the salts of the diamides of sulfosuccinic acid.

The preferred salts are alkali metal salts, ammonium salts, and mono-, di- and tri-alkanolammonium salts, such as mono-, di- or triethanolammonium salts, especially lithium, sodium, potassium or ammonium salts, particularly preferably sodium or ammonium salts, and extremely preferably sodium salts.

In the sulfosuccinates, it is preferable for one or both carboxyl groups of the sulfosuccinic acid to be esterified with two identical or different, branched or unbranched, saturated or unsaturated, acyclic or cyclic, optionally alkoxylated alcohols having 4 to 22, preferably 6 to 20, particularly 8 to 18, especially preferably 10 to 16, extremely preferably 12 to 14 carbon atoms. Particularly preferred esters are those of unbranched and/or saturated and/or acyclic and/or alkoxylated alcohols, especially unbranched saturated fatty alcohols and/or unbranched saturated fatty alcohols alkoxylated with ethylene oxide and/or propylene oxide, preferably ethylene oxide, with an degree of alkoxylation of 1 to 20, preferably 1 to 15, particularly 1 to 10, especially preferably 1 to 6, extremely preferably 1 to 4. The monoesters are preferred over the diesters in the structure of the present invention. One particularly preferred sulfosuccinate is sulfosuccinic acid lauryl polyglycol ester disodium salt (Lauryl-EO-sulfosuccinate, disodium salt; INCI disodium laureth sulfosuccinate), which is commercially available as Tego® Sulfosuccinat F 30 (Goldschmidt) with a sulfosuccinate content of 30% by weight.

In the sulfosuccinamates or sulfosuccinamides, one or both carboxyl groups of the sulfosuccinic acid form a carboxylic acid amide with a primary or secondary amine having one or two identical or different branched or unbranched, saturated or unsaturated, acyclic or cyclic, optionally alkoxylated alkyl groups having 4 to 22, preferably 6 to 20, especially 8 to 18, especially preferably 10 to 16, extremely preferably 12 to 14 carbon atoms. Unbranched and/or saturated and/or acyclic alkyl groups, especially unbranched fatty alkyl groups, are particularly preferred.

The following sulfosuccinates and sulfosuccinamates, named according to INCI and described in more detail in the International Cosmetic Ingredient Dictionary and Handbook are also suitable: ammonium dinonyl sulfosuccinate, ammonium lauryl sulfosuccinate, diammonium dimethicone copolyol sulfosuccinate, diammonium lauramido-MEA sulfosuccinate, diammonium lauryl sulfosuccinate, diammonium oleamido PEG-2 sulfosuccinate, diamyl sodium sulfosuccinate, dicapryl sodium sulfosuccinate, dicyclohexyl sodium sulfosuccinate, diheptyl sodium sulfosuccinate, dihexyl sodium sulfosuccinate, diisobutyl sodium sulfosuccinate, dioctyl sodium sulfosuccinate, disodium cetearyl sulfosuccinate, disodium cocamido MEA-sulfosuccinate, disodium cocamidoglucoside sulfosuccinate, disodium cocoyl butyl gluceth-10 sulfosuccinate, disodium C12-15 pareth sulfosuccinate, disodium deceth-5 sulfosuccinate, disodium deceth-6 sulfosuccinate, disodium dihydroxyethyl sulfosuccinyl undecylenate, disodium dimethicone copolyol sulfosuccinate, disodium hydrogenated cottonseed glyceride sulfosuccinate, disodium isodecyl sulfosuccinate, disodium isostearamido MEA-sulfosuccinate, disodium isostearamido MIPA-sulfosuccinate, disodium isostearyl sulfosuccinate, disodium laneth-5 sulfosuccinate, disodium lauramido PEG-5 sulfosuccinate, disodium laureth-6 sulfosuccinate, disodium laureth-9 sulfosuccinate, disodium laureth-12 sulfosuccinate, disodium lauryl sulfosuccinate, disodium myristamido MEA-sulfosuccinate, disodium nonoxynol-10 sulfosuccinate, disodium oleamido MEA-sulfosuccinate, disodium oleamido MIPA sulfosuccinate, disodium oleamido PEG-2 sulfosuccinate, disodium oleth-3 sulfosuccinate, disodium oleyl sulfosuccinate, disodium palmitamido PEG-2 sulfosuccinate, disodium palmitoleamido PEG-2 sulfosuccinate, disodium PEG4 cocamido MIPA-sulfosuccinate, disodium PEG-5 laurylcitrate sulfosuccinate, disodium PEG-8 palm glycerides sulfosuccinate, disodium ricinoleamido MEA-sulfosuccinate, disodium sitostereth-14 sulfosuccinate, disodium stearamido MEA-sulfosuccinate, disodium stearyl sulfosuccinamate, disodium stearyl sulfosuccinate, disodium tallamido MEA-sulfosuccinate, disodium tallowamido MEA-sulfosuccinate, disodium tallow sulfosuccinamate, disodium tridecyl-sulfosuccinate, disodium undecylenamido MEA-sulfosuccinate, disodium undecylenamido PEG-2 sulfosuccinate, disodium what germamido MEA-sulfosuccinate, disodium wheat germamido PEG-2 sulfosuccinate, di-TEA-oleamido PEG-2 sulfosuccinate, ditridecyl sodium sulfosuccinate, sodium bisglycol ricinosulfosuccinate, sodium/MEA Laureth-2 sulfosuccinate and tetrasodium dicarboxethyl stearyl sulfosuccinamate. Disodium C₁₆₋₁₈-alkoxypropylene sulfosuccinamate is still another suitable sulfosuccinamate.

The concentration of anionic surfactants in the agents according to the invention, preferably the anionic surfactants named, can vary within wide limits, depending on the purpose for which the agent in question is to be used. For instance, an agent according to the invention can contain very large proportions of anionic surfactant, preferably up to an order of magnitude of up to 40, 50 or 60% by weight or more. Likewise, an agent according to the invention can contain only very small proportions of anionic surfactants, for example less than 15 or 10% by weight or less than 5% by weight or even less. However, anionic surfactants can advantageously be contained in the agents according to the invention in quantities of 2 to 35% by weight and especially 5 to 30% by weight, with concentrations above 10% by weight and even above 15% by weight finding special preference. According to a preferred embodiment, the product according to the invention contains anionic surfactants, preferably in proportions of at least 0.1% by weight.

The agents according to the invention can contain soaps in addition to the anionic surfactants named, but also independently of them. Saturated fatty acid soaps are particularly suitable, such as the salts of lauric acid, myristic acid, palmitic acid, stearic acid, hydrogenated erucic acid and behenic acid, and particularly soap mixtures derived from natural fatty acids, such as coco, palm fatty acids or tallow fatty acids. The concentration of soaps in the agent is, independently of the other surfactants, preferably not more than 3% by weight, and especially 0.5 to 2.5% by weight.

The anionic surfactants and soaps can be in the form of their sodium, potassium or ammonium salts, as well as soluble salts of organic bases, such as mono-, di- or tri-ethanolamine. They are preferably in the form of their sodium or potassium salts, especially as the sodium salts. Anionic surfactants and soaps can also be produced in situ, in which process the anionic surfactant acids and optionally fatty acids are introduced into the composition to be spray-dried, and are then neutralized by the alkali carriers in the composition to be spray-dried.

The agents according to the invention can likewise advantageously contain nonionic surfactants, both in solid and liquid agents. For example, they can contain up to 2 or 3 or 5% by weight. Larger proportions of nonionic surfactants can also be contained, for instance, up to 5% by weight or 10% by weight or 15% by weight or 20% by weight or 30% by weight or even more, if convenient. Reasonable lower limits can lie at values of 1, 2, 3 or 4% by weight.

Preferably, though, the nonionic surfactants can be contained in larger quantities, that is, up to 50% by weight, more advantageously 0.1 to 40% by weight, particularly preferably 0.5 to 30 and especially 2 to 25% by weight, based in each case on the complete agent. According to a preferred embodiment the product according to the invention contains nonionic surfactants, preferably in proportions of at least 0.1% by weight.

All the nonionic surfactants known in the state of the art can be contained advantageously in the agents according to the invention. Preferred nonionic surfactants are presented below.

The agents according to the invention, such as in particular cleaners, care agents and detergents, can also preferably contain cationic surfactants. Suitable cationic surfactants are, for example, surface-active quaternary compounds, especially those with an ammonium, sulfonium, phosphonium, iodonium or arsonium group. By use of quaternary surface-active compounds with antimicrobial activity, the agent can be designed to have antimicrobial action, or existing antimicrobial action possibly due to other ingredients can be improved.

Particularly preferred cationic surfactants are the quaternary ammonium compounds, some of which have antimicrobial activity (QAC; INCI Quaternary ammonium compounds), having the general formula (R^{I})(R^{II})(R^{III})(R^{IV})N⁺X⁻, in which the R^{I} to R^{IV} are identical or different C₁₋₂₂ alkyl groups, C₇₋₂₈ aralkyl groups, or heterocyclic groups, in which two or, in the case of an aromatic bond as in pyridine, even three groups bond with the nitrogen atom of the heterocycle, making for instance a pyridinium or imidazolinium compound, and X⁻ are halide ions, sulfate ions, hydroxide ions, or similar ions. For optimal antimicrobial activity, it is preferable for at least one of the groups to have a chain length of 8 to 18, especially 12 to 16, carbon atoms.

QAC can be produced by reaction of tertiary amines with alkylating agents such as methyl chloride, benzyl chloride, dimethyl sulfate, dodecyl bromide or even ethylene oxide. Alkylation of tertiary amines with one long alkyl group and two methyl groups is particularly successful. Quaternization of tertiary amines having two long groups and one methyl group can be done with methyl chloride under mild conditions. Amines that have three long alkyl groups or hydroxy-substituted alkyl groups are less reactive and are preferably quaternized with dimethyl sulfate.

Examples of suitable QACs include benzalkonium chloride (N-alkyl-N,N-dimethyl benzylammonium chloride, CAS No. 8001-54-5), Benzalkone B (m, p-dichlorobenzyl-dimethyl-C₁₂-alkylammonium chloride, CAS No. 58390-78-6), benzoxonium chloride (benzyl-dodecyl-bis-2-hydroxyethylammonium chloride), cetrimonium bromide (N-hexadecyl-N,N-trimethylammonium bromide, CAS No. 57-09-0), benzethonium chloride (N,N-dimethyl-[2-[2-[p-(1,1,3,3-tetramethylbutyl)phenoxy]ethoxy]ethyl]benzylammonium chloride, CAS No. 121-54-09), dialkyldimethylammonium chlorides such as di-N-decyl-dimethylammonium chloride (CAS No. 7173-51-5-5), didecyldimethylammonium bromide (CAS No. 2390-68-3), dioctyl dimethylammonium chloride, 1-cetylpyridinium chloride (CAS No. 123-03-5) and thiazoline iodide (CAS No. 15764-481), and mixtures of them. The preferred QACs are the benzalkonium chlorides with C₈-C₁₈ groups, especially C₁₂-C₁₄-alkylbenzyldimethylammonium chloride. A specially preferred QAC is coco pentaethoxymethylammonium methosulfate (INCI PEG-5 cocomonium methosulfate; Rewoquat® CPEM.

To avoid potential incompatibilities of the antimicrobial cationic surfactants with the anionic surfactants that may be contained in the agent according to the invention, one uses cationic surfactants that are as compatible as possible with the cationic surfactants, or uses as little cationic surfactant as possible, or completely avoids cationic surfactants in a special embodiment of the invention.

Cationic surfactants as well as quaternary ammonium compounds are described below in connection with conditioning agents and softeners. These, too, can preferably be contained in the agents according to the invention.

The agents according to the invention, such as preferably detergents, care agents, and cleaners, can contain one or more cationic surfactants, advantageously in proportions, based on the complete composition, of 0 to 30% by weight, still more advantageously greater than 0 to 20% by weight, preferably 0.01 to 10% by weight, particularly 0.1 to 5% by weight. Suitable minimum values can also lie at 0.5, 1, 2 or 3% by weight. According to a preferred embodiment, the product according to the invention contains cationic surfactants, preferably in proportions of at least 0.1% by weight.

The agents according to the invention such as preferably detergents, care agents, and cleaners, can also contain amphoteric surfactants. Those are described in more detail below, particularly in connection with conditioning agents and softeners.

The agents according to the invention, such as preferably detergents, care agents, and cleaners, can contain one or more amphoteric surfactants advantageously in proportions, based on the complete composition, of 0 to 30% by weight, still more advantageously greater than 0 to 20% by weight, preferably 0.01 to 10% by weight, especially 0.1 to 5% by weight.

Other ingredients of the agents according to the invention can be inorganic and organic builders. The inorganic builders include water-insoluble or non-water-soluble ingredients, such as aluminosilicates and in particular, zeolites.

In a preferred embodiment, the agent according to the invention contains no phosphate and/or no zeolite. It is also possible, though, for the agent to contain zeolite. It can be preferred that the zeolite proportion, based on the total weight of the agent, amounts to less than 5% by weight, preferably not more than 4% by weight, maximally 3% by weight, or maximally 2% by weight.

However, it can also be provided that the agent according to the invention has a zeolite content of at least 10% by weight, e.g., at least 15% by weight or at least 20% by weight or at least 30% by weight or, even more than that, for example, at least 50% by weight.

The agent according to the invention can contain soluble builders preferably in proportions of 10% by weight to 30% by weight, preferably 15% by weight to 25% by weight, and especially preferably 18% by weight to 20% by weight, with sodium carbonate especially preferred as the soluble builder. But it can also be advantageous to provide that the agent according to the invention contain less than 10% by weight, e.g., less than 5% by weight of soluble builder.

Zeolite A and/or zeolite P are usable zeolites that are finely crystalline, synthetic, and contain water. Zeolite MAP® (commercial product of the Crosfield company), for example, is particularly preferred as zeolite P. However, zeolite X is also suitable, as well as mixtures of A, X and/or P. A sodium/potassium-aluminum silicate cocrystallized from zeolite A and zeolite X is of special interest. It is commercially available as VEGOBOND AX® (commercial product of Condea Augusta S.p.A.) This product is described in more detail below. The zeolite can be used as a spray-dried powder, or as an undried stabilized suspension, still moist from its preparation. In case the zeolite is used as a suspension, it can contain slight additions of nonionic surfactants as stabilizers, for instance, 1 to 3% by weight, based on the zeolite, of ethoxylated C₁₂-C₁₈-fatty alcohols with 2 to 5 ethylene oxide groups, C₁₂-C₁₄ fatty alcohols with 4 to 5 ethylene oxide groups, or ethoxylated isotridecanols. Suitable zeolites have a mean particle size preferably less than 10 μm (volume distribution; measurement method. Coulter counter) and contain preferably 18 to 22% by weight, especially 20 to 22% by weight of bound water.

Zeolites of the faujasite type must be noted as other particularly suitable zeolites. The mineral faujasite, along with zeolites X and Y, belong to the faujasite type within zeolite structure group 4, which is characterized by the double-six-ring unit D6R. The zeolite structure group 4 includes, along with the faujasite types, the minerals chabazite and gmelinite, and the synthetic zeolites R (chabazite type), S (gmelinite type), L and ZK-5. The latter two synthetic zeolites have no mineral analogs.

Zeolites of the faujasite type are built up of β-cages linked tetrahedrally through D6R subunits, in which the β-cages are arranged similarly to the carbon atoms in diamonds. The three-dimensional network of the suitable zeolites of the faujasite type according to the invention has pores of 2.2 and 7.4 Å. The elementary cell also contains 8 cavities about 13 Å in diameter, and can be described by the formula Na₈₆[(AlO₂)]₈₆(SiO₂)₁₀₆].264H₂O. The network of zeolite X thus has a cavity volume of about 50%, based on the dehydrated crystal. That is the greatest cavity volume of all known zeolites (zeolite Y: cavity volume ca. 48%; faujasite: ca. 47% cavity volume).

Within the present invention, the concept “zeolite of the faujasite type” characterizes all three zeolites, which form the faujasite subgroup of zeolite structure group 4. Aside from zeolite X, zeolite Y and faujasite, as well as mixtures of those compounds are suitable according to the invention, with the pure zeolite X preferred.

Mixtures or cocrystallizates of zeolites of the faujasite type with other zeolites, which do not absolutely have to be in zeolite structural group 4, are suitable according to the invention, with preferably at least 50% by weight of the zeolite being of the faujasite type.

The suitable aluminum silicates are commercially available, and the methods for producing them are described in standard monographs.

Examples of commercially available zeolites of the X type can be described by the following formulas:

Na₈₆[(AlO₂)₈₆(SiO₂)₁₀₆].xH₂O,

K₈₆[(AlO₂)₈₆(SiO₂)₁₀₆].xH₂O

Ca₄₀Na₆[(AlO₂)₈₆(SiO₂)₁₀₆].xH₂O,

Sr₂₁Ba₂₂[(AlO₂)₈₆(SiO₂)₁₀₆].xH₂O,

in which x values of the magnitude of 0 to 276 can be assumed. These zeolites have pore sizes of 8.0 to 8.4 Å.

Zeolite A-LSX is also suitable, for example. It is a cocrystallizate of zeolite X and zeolite A, and in its anhydrous form has the formula (M_{2/n}O+M′_{2/n}O).Al₂O₃.z SiO₂, in which M and M′ can be alkali or alkaline earth metals and z is a number from 2.1 to 2.6. This product is commercially available from CONDEA Augusta S.p.A. under the tradename VEGOBOND AX.

Zeolites of the Y type are also commercially available. They can be represented by the formulas

Na₅₆[(AlO₂)₅₆(SiO₂)₁₃₆].xH₂O,

K₅₆[(AlO₂)₅₆(SiO₂)₁₃₆].xH₂O,

in which x stands for numbers of the magnitudes of 0 to 276. These zeolites have pore sizes of 8.0 Å.

The particle sizes of the suitable zeolites are advantageously in the range of 0.1 μm to 100 um to 100 um, preferably 0.5 μm to 50 μm and especially from 1 μm to 30 μm, measured in each case with standard methods for particle size determination.

In a preferred embodiment of the invention, all the inorganic components contained should preferably be water-soluble. In these embodiments, therefore, other builder substances than the zeolites named are used.

Other suitable builders are polyacetals, which can be obtained by reacting of dialdehydes with polyolcarboxylic acids having 5 to 7 C atoms and at least 3 hydroxyl groups. Preferred polyacetals are obtained from dialdehydes such as glyoxal, glutaraldehyde, terephthalaldehyde and their mixtures, and from polyolcarboxylic acids such as gluconic and/or glucoheptonic acid.

Other suitable organic builder substances are dextrins, for instance, oligomers or polymers of carbohydrates, which can be obtained by partial hydrolysis of starches. The hydrolyses can be carried out by the usual methods, such as acid-catalyzed or enzyme-catalyzed processes. Preferably the hydrolysis products have average molecular weights in the range of 400 to 500,000 g/mole. Here a polysaccharide having a dextrose equivalent (DE) in the range of 0.5 to 40 is preferred, especially of 2 to 30. DE is a useful measure of the reducing action of a polysaccharide in comparison with dextrose, which has a DE of 100. Both maltodextrins with a DE between 3 and 20 and dried glucose syrups with a DE between 20 and 37 are usable, as well as so-called yellow dextrins and white dextrins with higher molecular weights in the range of 2,000 to 30,000 g/mole. One preferred dextrin is described in British patent application 94 19 091. The oxidized derivatives of such dextrins are their reaction products with oxidizing agents that can oxidize at least one alcohol function of the saccharide ring to a carboxylic acid function.

Oxydisuccinates and other derivatives of disuccinates, preferably ethylenediamine disuccinate, are other suitable cobuilders. Ethylenediamine-N,N′-disuccinate (EDDS) is preferably used in the form of its sodium or magnesium salt. Glycerol disuccinate and glycerol trisuccinate are also preferred in the connection. Suitable proportions to be used are, for example, in the range of 3 to 15% by weight, based on the complete agent.

Acetylated hydroxycarboxylic acids or their salts, which may also be in the lactone form if desired, and which contain at least 4 carbon atoms and at least one hydroxy group, as well as not more than two acid groups, are examples of other usable organic cobuilders.

The phosphonates represent another class of substances with cobuilder properties. These are particularly hydroxyalkane or aminoalkane phosphonates. Of the hydroxyalkane phosphonates, 1-hydroxyethane-1,1-diphosphonate (HEDP) is of particular importance as a cobuilder. It is used preferably as the sodium salt, with the disodium salt being neutral and the tetrasodium salt alkaline (pH 9). The aminoalkane phosphonates considered are primarily ethylenediamine tetramethylene phosphonate (EDTMP), diethylenetriamine pentamethylene phosphonate (DTPMP), and their higher homologs. They are used preferably in the form of their neutral sodium salts, such as the hexasodium salt of EDTMP or as the hepta- and octa-sodium salt of DTPMP. HEDP is used preferably as a builder of the phosphonate class. The aminoalkane phosphonates also have an outstanding ability to bind heavy metals. As a result, it can be preferred to use aminoalkane phosphonates, especially DTPMP, or mixtures of the phosphonates named, especially if the agents also contain bleaches.

Phosphates, particularly pentasodium triphosphate, and optionally also pyrophosphate and orthophosphate, can also be used in cases in which the phosphate content is tolerated. They act primarily as agents to precipitate calcium salts. Phosphates are used predominantly in dishwashing machine agents, but also to some extent in detergents. Alkali metal phosphate is the summary term for the alkali metal (especially sodium and potassium) salts of the various phosphoric acids, in which one can distinguish metaphosphoric acids (HPO₃)ₙ and orthophosphoric acid H₃PO₄ from higher-molecular-weight representatives. The phosphates combine several advantages: they act as alkali carriers, prevent deposition of lime on machine parts and lime incrustations in cloth, and also contribute to the cleaning power.

Sodium dihydrogen phosphate, NaH₂PO₄ exists as the dihydrate (density 1.91 g/cm³, melting point 60°) and as the monohydrate (density 2.04 g/cm³). Both salts are white and very easily soluble in water. They lose water of crystallization on heating. At 200° C. they transform into the weakly acidic diphosphate (disodium hydrogen diphosphate, Na₂H₂P₂O₇) and, at higher temperatures, into sodium trimetaphosphate (Na₃P₃O₉) and Maddrell's Salt (see below). NaH₂PO₄ has acidic reaction. It occurs if phosphoric acid is adjusted with sodium hydroxide to a pH of 4.5 and the suspension is spray-dried. Potassium dihydrogen phosphate (primary or monobasic potassium phosphate, calcium biphosphate, KDP), KH₂PO₄, is a white salt with a density of 2.33 q/cm³. It has a melting point of 253° [decomposes, forming potassium polyphosphate, (KPO₃)ₓ], and is easily soluble in water.

Disodium hydrogen phosphate (secondary sodium phosphate), Na₂HPO_{4′} is a colorless crystalline salt very easily soluble in water. It exists anhydrous and with 2 moles of water (density 2.066 g/cm³, water lost at 95°), with 7 moles of water (density 1.68 g/cm³, melting point 48°, with loss of 5 H₂O) and with 12 moles of water (density 1.52 g/cm³, melting point 35° with loss of 5H₂O), and becomes anhydrous at 100°. It transforms to the diphosphate, Na₄P₂O₇, on stronger heating. Disodium hydrogen phosphate is produced by neutralizing phosphoric acid with soda solution, using phenolphthalein as the indicator. Dipotassium hydrogen phosphate (secondary or dibasic potassium phosphate), K₂HPO₄, is an amorphous white salt that is easily soluble in water.

Trisodium phosphate, tertiary sodium phosphate, Na₃PO₄, is colorless crystals which, as the dodecahydrate, have a density of 1.62 g/cm³ and a melting point of 73-76° C. (decomposition). As the decahydrate (equivalent to 19-20% P₂O₅) it has a melting point of 100° C., and in the anhydrous form (corresponding to 39-40% P₂O₅) it has a density of 2.536 g/cm³. Trisodium phosphate is easily soluble in water, with an alkaline reaction. It is produced by evaporating a solution of exactly 1 mole of disodium phosphate and 1 mole of NaOH. Tripotassium phosphate (tertiary or tribasic potassium phosphate), K₃PO₄, is a white, deliquescent granular powder with a density of 2.56 g/cm³, and a melting point of 1340° C. It is easily soluble in water with an alkaline reaction. It is produced, for example, by heating basic slag with coal and potassium sulfate. The more easily soluble, and thus more effective potassium phosphate is often preferred in the cleaner industry over the corresponding sodium compounds in spite of its higher price.

Tetrasodium diphosphate (sodium pyrophosphate), Na₄P₂O₇, exists in the anhydrous form (density 2.534 g/cm³, melting point 988°, even 88° reported) and as the decahydrate (density 1.815-1.836 g/cm³ melting point 94°, with loss of water). Both substances are colorless crystals that dissolve in water to give an alkaline reaction. Na₄P₂O₇ appears when disodium phosphate is heated to >200°, or if phosphoric acid is mixed with soda in the stoichiometric ratio and the solution is spray-died. The decahydrate complexes heavy metal salts and hardness components, thus reducing the hardness of water. Potassium diphosphate (potassium pyrophosphate), K₄P₂O₇, exists as the trihydrate. It is a colorless hygroscopic powder with a density of 2.33 g/cm³, which is soluble in water. The pH of a 1% solution at 25° is 10.4.

Condensation of NaH₂PO₄ or of KH₂PO₄ gives higher molecular weight sodium and calcium phosphates, in which one can distinguish cyclic representatives, the sodium or potassium metaphosphates, and the chain-like types, sodium or potassium polyphosphates. There are numerous names in use, especially for the latter: fused or ignited phosphate, Graham's salt, Kurrol's and Maddrell's salt. All the higher sodium and potassium phosphates are called condensed phosphates as a group.

The industrially important pentasodium triphosphate, Na₅P₃O₁₀ (sodium tripolyphosphate) is a non-hygroscopic white water-soluble salt having the general formula NaO—[P(O)(ONa)—O]ₙ, with n=3. It crystallizes anhydrous or with 6H₂O. Its solubility in water is about 17 g/100 g at room temperature, about 20 g/100 g at 60° and, at 100°, about 32 g of the anhydrous salt per 100 g. Heating of the solution at 100° for two hours gives about 8% orthophosphate and 15% disphosphate due to hydrolysis. In production of pentasodium triphosphate, phosphoric acid is reacted with soda solution or sodium hydroxide in stoichiometric ratio and the solution is spray-dried. Like Graham's salt and sodium diphosphate, pentasodium triphosphate dissolves many insoluble metal compounds (including lime soaps, etc.). Pentapotassium tripolyphosphate, K₅P₃O₁₀, occurs commercially, for example, in the form of a 50% by weight solution (>23% P₂O₅, 25% K₂O). The potassium polyphosphates are widely used in detergents and cleaners. There are also sodium-potassium tripolyphosphates, which are also useful in the framework of the present invention. Those arise, for example, if sodium trimetaphosphate is hydrolyzed with KOH.

(NaPO₃)₃+2KOH→Na₃K₂P₃O₁₀+H₂O

These are, according to the invention, usable just like sodium tripolyphosphate, potassium tripolyphosphate or mixtures of the two. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate are also usable according to the invention.

In a preferred embodiment of the invention, carbonates and silicates are used as inorganic builders.

Here one must note in particular the crystalline lamellar sodium silicates of the general formula NaMSiₓO₂ₓ₊₁.y H₂O, in which M means sodium or potassium, x is a number from 1.6 to 4, preferably 1.9 to 4.0, and y is a number from 0 to 20, and preferred values of x are 2, 3 or 4. However, as such crystalline silicates at least partially lose their crystalline structure in a spray-drying process, crystalline silicates are preferably added to the product of spray-drying to be processed immediately or later. Preferred crystalline lamellar silicates of the formula presented are those in which M stands for sodium and x has the value of 2 or 3. Both β- and δ-sodium disilicates, Na₂Si₂O₅.y H₂O, are preferred Such compounds are found in commerce, for example, under the name SKS® (Clariant). SKS-6 is primarily a δ-sodium disilicate with the formula Na₂Si₂O₅.y H₂O, SKS-7® is primarily the β-sodium disilicate. Reaction with acids (e.g., citric acid or carbonic acid) produces kanemite from 6-sodium disilicate. Kanemite, NaHSi₂O₅.y H₂O, is commercially available under the names SKS-9® and SKS-10® (Clariant). It can also be advantageous to use chemical modifications of these lamellar silicates. For example, the alkalinity of the lamellar silicate can be influenced appropriately. Lamellar silicates with added phosphate or carbonate exhibit altered crystal morphologies, compared with δ-sodium disilicate. They dissolve faster and have higher calcium-binding capabilities than δ-sodium disilicate. For instance, lamellar silicates of the general empirical formula x Na₂O.y SiO₂.z P₂O₅ are known, in which the ratio of x to y is a number from 0.35 to 0.6, the ratio of x to z is a number from 1.75 to 1200, and the ratio of y to z is a number from 4 to 2800. The solubility of the lamellar silicate can also be increased if particularly finely divided lamellar silicates are used. Compounds from the crystalline laminar silicates with other ingredients can also be used. Compounds to be mentioned particularly are compounds with cellulose derivatives, which have advantages in their disintegrating effect, and compounds with polycarboxylates such as citric acid or polymeric polycarboxylates, such as copolymers of acrylic acid.

The preferred builders also include amorphous sodium silicates having the ratio of Na₂O to SiO₂ from 1:2 to 1:3.3, preferably 1:2 to 1:2.8 and especially 1:2 to 1:2.6. Those have secondary washing properties. In the context of this invention, the concept of “amorphous” is also understood to mean “amorphous by X-ray”. That means that the silicates do now show any sharp X-ray reflections in X-ray diffraction tests, as are typical for crystalline substances. Instead they always exhibit one or more maxima for the scattered X-radiation, indicating a range of several degrees for the angle of diffraction. However, the builder properties can be very good to especially good if the silicate particles give faded or even sharp diffraction maxima in electron diffraction tests. This must be interpreted as showing that the products have microcrystalline regions from 10 to a few hundred nm in size, while values not more than 50 nm and preferably not more than 20 nm are preferred. Such so-called “X-ray amorphous” silicates, which also exhibit slower dissolution than the usual water glasses, are known. Particularly preferred are compressed/compacted amorphous silicates, compounded amorphous silicates, and superdried X-ray amorphous silicates. The content of (X-ray) amorphous silicates in zeolite-free agents in particular is preferably 1 to 10% by weight, corresponding to a preferred embodiment of the invention.

Alkali metal carbonates and alkali metal bicarbonates are particularly preferred inorganic water-soluble builders, with sodium and potassium carbonate, and especially sodium carbonate, being the preferred embodiments. The concentration of the alkali metal carbonates in agents which are particularly zeolite-free can vary within very wide limits, and is preferably 5 to 40% by weight, especially 8 to 30% by weight. The concentration of alkali metal carbonates is usually higher than that of (X-ray) amorphous silicates.

Examples of usable organic builders include the polycarboxylic acids, in the form of their alkali and especially sodium salts, such as citric acid, adipic acid, succinic acid, glutaric acid, tartaric acid, sugar acids, aminocarboxylic acids, nitrilotriacetic acid (NTA), to the extent that such use in not ecologically objectionable, and mixtures of them. Preferred salts are the salts of the polycarboxylic acids such as citric acid, adipic acid, succinic acid, glutaric acid, tartaric acid, sugar acids, aminocarboxylic acids and mixtures of them. The acids themselves can also be used. The acids have, aside from their builder action, typically also the property of acidifying components and thus serve, as in the granulations according to the invention, to adjust a lower and milder pH of the detergents and cleaners. Citric acid, succinic acid, glutaric acid, adipic acid, gluconic acid, and arbitrary mixtures of them must be mentioned in particular.

Other polymeric polycarboxylates are suitable as organic builders. They are, for example, the alkali metal salts of polyacrylic acid or polymethacrylic acid, such as those with a relative molecular weight of 500 to 70,000 g/mol. The molecular weights stated for the polymeric polycarboxylates are, in the sense of this document, weight-average molecular weights M_{w} of the particular acid form, determined basically by gel permeation chromatography (GPC), with a UV detector. The measurement is done with an external polyacrylic acid standard. That gives realistic molecular weights because of its structural relation to the polymers being investigated. These data depart distinctly from the molecular weight figures from use of polystyrenesulfonic acids as standards. The molecular weights measured using polystyrenesulfonic acids are as a rule clearly higher than those stated in this document.

The agents according to the invention can also contain polymers, especially as carriers for the perfume oils (fragrances). Suitable polymers that can also be used as carriers in conjunction with fragrances, include in particular polyacrylates, which preferably have molecular weights of 2,000 to 20,000 g/mol. From this group, again, the short-chain polyacrylates having molecular weights of 2,000 to 10,000 g/mol are preferred because of their superior solubility, and especially preferably those of 3,000 to 5,000 g/mol.

Other copolymeric polycarboxylates are also suitable, especially those of acrylic acid with methacrylic acid and of acrylic acid or methacrylic acid with maleic acid. Those copolymers of acrylic acid with maleic acid that contain 50 to 90% by weight acrylic acid and 50 to 10% by weight maleic acid prove to be particularly suitable. Their relative molecular weights, based on the free acids, are generally 2,000 to 70,000 g/mol, preferably 30,000 to 50,000 g/mol, and especially 30,000 to 40,000 g/mol.

The content of organic builder substances in the agents can vary within wide limits. Concentrations of 2 to 20% by weight are preferred, with contents not greater than 10% by weight finding particular approval.

The agents according to the invention can have components from the classes of graying inhibitors (antiredeposition agents), which have neutral salts and/or textile-softening additives (such as cationic surfactants), which is preferred.

The function of the antiredeposition agents is to keep the dirt removed from the fibers suspended in the liquid and so to prevent it being picked up again. Water-soluble colloids, mostly of organic nature, are suitable for this. Examples include the water-soluble salts of polymeric carboxylic acids, mucilage, gelatin, salts of ethercarboxylic acids or ethersulfonic acids of starch or cellulose, or salts of acidic sulfuric acid esters of cellulose or starch. Water-soluble polyamides containing acidic groups are also suitable for this purpose. Soluble starch preparations and starch products other than those named above can also be used, e.g., degraded starches, aldehyde starches, etc. Polyvinylpyrrolidone is also usable. However, cellulose ethers are preferred, such as carboxymethylcellulose (sodium salt), methylcellulose, hydroxyalkylcellulose, and mixed ethers, such as methyl hydroxyethyl cellulose, methyl hydroxypropyl cellulose, methyl carboxymethyl cellulose and mixtures of them, as well as polyvinylpyrrolidone, in proportions, for instance, of preferably 0.1 to 5% by weight, based on the agent.

Sodium sulfate must be named as a typical example of a suitable member of the neutral salts. It can be used in proportions of, for example, 0 to 60% by weight, preferably 2 to 45% by weight.

Suitable softeners, which are described in more detail below, are, for example, swellable lamellar silicates of the type corresponding to montmorillonite, such as bentonite, as well as cationic surfactants.

The water content of the agent depends on, among other things, whether the agent is solid or liquid, and so amounts preferably to 0 to less than 100% by weight, and especially 0.5 to 95% by weight, with values of not more than 5% by weight being particularly preferred especially for solid or nonaqueous liquid agents. In the case of solid agents, this does not consider the water that may adhere to aluminosilicates such as zeolite.

In the case of liquid agents, the agent according to the invention, according to a preferred embodiment, contains water in an proportion of more than 20% by weight, advantageously more than 30% by weight, still more advantageously more than 40% by weight, still more advantageously more than 50% by weight, especially 60 to 95% by weight, especially preferably 70 to 93% by weight, and extremely preferably 80 to 90% by weight.

The agent according to the invention, if it is a solid, can have outstanding flow behavior. According to a preferred embodiment the agent according to the invention is essentially solid, being preferably in powdered, pressed or granular form.

If the agent is in particulate form, the particles can be post-treated, such as by rounding the particles of the agent. The rounding can be done in a usual manner. The rounding time is preferably not longer than 4 minutes, especially not longer than 3.5 minutes. Rounding times of not more than 1.5 minutes or less are especially preferred. The rounding attains further uniformity of the particle size range, as agglomerates that may occur are reduced in size.

An agent according to the invention in particle form can be post-treated in a usual manner, preferably in a mixer or optionally in a fluidized bed, particularly with nonionic surfactants, perfume oil (fragrances) and/or foam inhibitors or preparation forms that contain these ingredients, preferably with proportions of up to 20% by weight active substances, especially with proportions of 2 to 18% by weight, based in each case on the post-treated product.

In particular, an agent according to the invention can likewise be post-treated or powdered off with solids, preferably in proportions of up to 15% by weight, especially in proportions of 2 to 15% by weight, based in each case on the total weight of the agent being post-treated.

The solids used for the post-treatment can preferably be bicarbonate, carbonate, zeolite, silicic acid, citrate, urea, or mixtures of those, especially in proportions of 2 to 15% by weight, based on the total weight of the post-treated product. The post-treatment can be done in an advantageous manner in a mixer and/or by means of spheroidizers

In a preferred embodiment of the invention, an agent according to the invention is post-treated with nonionic surfactants, which can for example also contain optical brighteners and/or hydrotropes, perfume (fragrance) and/or a solution of optical brighteners and/or foam inhibitors or preparation forms that can contain those ingredients, applied in liquid, fused or paste form to the particular agent that is to be post-treated.

Here it is preferred that the post-treatment with the substances named be done in an ordinary mixer, only, for example, in a 2-shaft mixer within not more than 1 minute, preferably within 30 seconds and, for example, within 20 seconds, with the time statements applicable simultaneously for the addition time and mixing time.

The nonionic surfactants will be described in more detail in the following. These nonionic surfactants can be applied to the particulate agent in a post-treatment step. Obviously, though, all nonionic surfactants can advantageously be contained directly in the agent according to the invention, which can be liquid or solid, or in the form of a foam or gel.

The nonionic surfactants used preferably are alkoxylated, preferably ethoxylated, particularly primary alcohols having preferably 8 to 18 C atoms and an average of 1 to 12 moles of ethylene oxide (EO) per mole of alcohol, in which the alcohol group is linear or preferably methyl-branched at the 2 position, or can contain linear and methyl-branched groups in the mixture, such as typically occur in oxoalcohol groups. Those alcohol ethoxylates are particularly preferred, though, that have linear groups from alcohols of native origin with 12 to 18 C atoms, such as from coco, palm, palm kernel, tallow or oleyl alcohol, and preferably an average of 2 to 8 EO groups per mole of alcohol. The preferred ethoxylated alcohols include, for example, C₁₂-C₁₄ alcohols with 3 EO or 4 EO, C₉-C₁₁-alcohols with 7 EO, C₁₃-C₁₅-alcohols with 3 EO, 5 EO, 7 EO or 8 EO, C₁₂-C₁₈-alcohols with 3 EO, 5 EO or 7 EO, and mixtures of them, such as mixtures of C₁₂-C₁₄-alcohol with 3 EO and C₁₂-C₁₈ alcohol with 7 EO. The stated degrees of ethoxylation are statistical averages, which can be integers or fractional numbers for a specific product.

Preferred alcohol ethoxylates have a narrowed homolog distribution (narrow range ethoxylates, NRE). In addition to these nonionic surfactants, fatty alcohols with more than 12 EO can also be used. Examples of those are (tallow) fatty alcohols with 14 EO, 16 EO, 20 EO, 25 EO, 30 EO or 40 EO.

Preferred nonionic surfactants are branched or unbranched, saturated or unsaturated C₁₀₋₂₂-alcohols singly or multiply alkoxylated with ethylene oxide (EO) and/or propylene oxide (PO), having a degree of alkoxylation up to 30, preferably ethoxylated C₁₀₋₁₈-fatty alcohols with a degree of ethoxylation of less than 30, preferably 1 to 20, especially 1 to 12, particularly preferably 1 to 8, extremely preferably 2 to 5, such as C₁₂₋₁₄-fatty alcohol ethoxylates with 2, 3, of 4 EO or a mixture of the C₁₂₋₁₄-fatty alcohol ethoxylates with 3 and 4 EO in the weight ratio of 1 to 1 or isotridecyl alcohol ethoxylate with 5, 8 or 12 EO.

Also, alkylglycosides having the general formula RO(G)ₓ in which R indicates a primary straight-chain or methyl-branched, especially methyl-branched in the 2 position, aliphatic group with 8 to 22, preferably 12 to 18 C atoms, and G is the symbol for a glycose unit with 5 or 6 C atoms, preferably glucose, can be used as other nonionic surfactants. The degree of oligomerization x, which states the distribution of monoglycosides and oligoglycosides, is an arbitrary number from 1 to 10. It is preferable for x to be 1.1 to 1.4.

Another class of nonionic surfactants used preferably, used either as the only nonionic surfactants or in combination with other nonionic surfactants, especially together with alkoxylated fatty alcohols and/or alkyl glycosides, is that of alkoxylated, preferably ethoxylated or ethoxylated and propoxylated fatty acid alkyl esters, preferably having 1 to 4 carbon atoms in the alkyl chain, especially fatty acid methyl esters such as are described in, for example, in Japanese Patent Application JP 58/217598, or which are preferably produced by the process described in International Patent Application WO-A-90/13533. C₁₂-C₁₈-fatty acid methyl esters with an average of 3 to 15 EO, especially with an average of 5 to 12 EO are particularly preferred.

Nonionic surfactants of the amine oxide type, such as N-cocoalkyl-N,N-dimethyl amine oxide and N-tallowalkyl-N,N-dihydroxyethyl amine oxide, and the fatty acid alkanolamides, can also be suitable. The proportion of these nonionic surfactants is preferably not greater than that of the ethoxylated fatty alcohols, particularly not greater than half of that.

Alkoxylated amines are also suitable. They are advantageously ethoxylated and/or propoxylated, especially primary and secondary amines having preferably 1 to 18 C atoms per alkyl chain and an average of 1 to 12 moles of ethylene oxide (EO) and/or 1 to 10 moles of propylene oxide (PO) per mole of amine.

Essentially all surfactants can be considered as surfactants for agents according to the invention that are particularly suited for machine dishwasher rinses, especially dish rinses in the form of molded tablets, such as tabs. However, the previously described nonionic surfactants are preferred for this application, and above all, the low-foaming nonionic surfactants. The alkoxylated alcohols are particularly preferred, especially the ethoxylated and/or propoxylated alcohols. Here one skilled in the art understands that alkoxylated alcohols are generally the reaction products of alkylene oxide, preferably ethylene oxide, with alcohols, preferably the longer-chain alcohols C₁₀ to C₁₈ in the sense of the present invention, preferably C₁₂ to C₁₆, such as C₁₁-, C₁₂-, C₁₃-, C₁₄-, C₁₅-, C₁₆-, C₁₇- and C₁₈-alcohols. As a rule, n moles of ethylene oxide and one mole of alcohol produce a complex mixture of addition products of different degrees of ethoxylation, depending on the reaction conditions. A further embodiment comprises the use of mixtures of the alkylene oxides, preferably a mixture of ethylene oxide and propylene oxide. One can also, if desired, arrive at the substance class of “closed” alcohol ethoxylates by terminal etherification with short-chain alkyl groups, such as, preferably the butyl group. They can likewise be used in the sense of the invention. Highly ethoxylated fatty alcohols or mixtures of them with the end-group terminated fatty alcohol ethoxylates are quite specially preferred in the sense of the present invention.

The agents according to the invention can advantageously also contain foam inhibitors, such as foam-inhibiting paraffin oil or foam-inhibiting silicone oil, for example dimethyl polysiloxane. It is also possible to use mixtures of these active substances. Substances that may be considered as solid additives at room temperature, especially with the foam-inhibiting active substances named, are paraffin waxes and silicic acids, which can also be hydrophobized in the known manner, and bis-amides derived from C₂₋₇ diamines and C₁₂₋₂₂-carboxylic acids.

Foam-inhibiting paraffin oils are considered preferable for use. They can also be mixed with paraffin waxes, and are generally complex mixtures of substances without a sharp melting point. For characterization, the melting range or the solidification point is usually determined by differential thermal analysis (DTA). The solidification point is understood to be the temperature at which the paraffin transforms from the liquid to the solid state on slow cooling. Paraffins with fewer than 17 C atoms are not usable according to the invention, and thus their proportion in the paraffin oil mixture should be as low as possible. It is preferably below the limit of significant measurement with the usual analytical methods, such as gas chromatography, for example. It is preferable to use paraffins that solidify in the range of 20° C. to 70° C. It must be noted that paraffin wax mixtures that appear solid even at room temperature can contain varying proportions of liquid paraffin oils. For the paraffin waxes usable according to the invention, the proportion of liquid is the highest possible at 40° C. without amounting to 100% at that temperature. Preferred paraffin wax mixtures have a liquid proportion of at least 50% by weight at 40° C., especially of 55% by weight to 80% by weight, and a liquid proportion of at least 90% by weight at 60° C. As a consequence the paraffins are flowable and pumpable at temperatures down to at least 70° C., preferably down to at least 60° C. It must also be noted that the paraffins must contain as little proportion of volatiles as possible. Preferred paraffin waxes contain less than 1% by weight, particularly less than 0.5% by weight of ingredients that vaporize at 110° C. and standard pressure. Paraffins usable according to the invention can, for example, be obtained under the trade names Lunaflex® from Fuller and Deawax® from DEA Mineralöl AG.

The paraffin oils can contain bis-amides that are solid at room temperature, derived from saturated fatty acids having 12 to 22, preferably 14 to 18 C atoms and from alkylenediamines having 2 to 7 C atoms. Suitable fatty acids are lauric, myristic, stearic, arachidic and behenic acids and mixtures of them, such as can be obtained from natural fats or solidified oils such as tallow or hydrogenated palm oil. Examples of suitable diamines are ethylenediamine, 1,3-propylenediamine, tetramethylenediamine, pentamethylenediamine, hexamethylenediamine, p-phenylendiamine and toluoylenediamine. Ethylenediamine and hexamethylenediamine are preferred diamines. Particularly preferred bis-amides are bis-myristoyl ethylenediamine, bis-palmitoyl ethylendiamine, bis-stearoyl ethylenediamine and mixtures of those, as well as the corresponding derivatives of hexamethylenediamine.

The products according to the invention can preferably be mixed with other ingredients, especially of detergents, care agents and/or cleaners or cosmetic ingredients. It is generally known from the broad state of the art which ingredients of detergents and cleaning agents and which raw materials can usually still be added. These are, for example, substances such as bleaching agents, bleach activators and/or bleach catalysts, enzymes, temperature-sensitive dyes, etc., which can of course also be contained directly in the agent.

The agents can preferably contain UV absorbers that advantageously adhere to the textiles being treated and which improve the light resistance of the fibers and/or the light resistance of other components of the formulation. UV absorbers are understood to be organic substance (light-protection filters) that can absorb ultraviolet rays and release the energy absorbed as longer-wave rays, such as heat. Compounds exhibiting these desired properties are, for example, the compounds that are active by nonradiative deactivation and derivatives of benzophenone having substituents in the 2- and/or 4-positions. Other suitable materials are substituted benzotriazoles, acrylates substituted by phenyl in the 3-position (cinnamic acid derivatives), optionally with cyano groups in the 2-position, salicylates, organic Ni complexes, and natural substances such as umbelliferone and the body's own urocanic acid. Biphenyl derivatives and especially stilbene derivatives, commercially available from Ciba as Tinosorb® FD or Tinosorb® FR are particularly important. UV-B absorbers that should be named include 3-benzylidenecamphor or 3-benzylidene-nor-camphor and their derivatives, such as 3-(4-methylbenzylidene)-camphor, 4-aminobenzoic acid derivatives, preferably 4-(dimethylamino)benzoic acid 2-ethylhexyl ester, 4-(dimethylamino)benzoic acid 2-octyl ester, and 4-(dimethylamino)benzoic acid amyl ester; esters of cinnamic acid, preferably 4-methoxycinnamic acid 2-ethylhexyl ester, 4-methoxycinnamic acid propyl ester, 4-methoxycinnamic acid amyl ester, 2-cyano-3,3-phenylcinnamic acid 2-ethylhexyl ester (Octocrylene); esters of salicylic acid, preferably salicylic acid 2-ethylhexyl ester, salicylic acid 4-isopropylbenzyl ester or salicylic acid homomethyl ester; derivatives of benzophenone, preferably 2-hydroxy-4-methoxybenzophenone, 2-hydroxy-4-methoxy-4′-methylbenzophenone, and 2,2′-dihydroxy-4-methoxybenzophenone; esters of benzalmalonic acid, preferably 4-methoxy benzalmalonic acid di-2-ethylhexyl ester; triazine derivatives, such as 2,4,6-trianilino-(p-carbo-2′-ethyl-1′-hexyloxy)-1,3,5-triazine and octyl triazone, or dioctyl butamido triazone (Uvasorb® HEB); propane-1,3-diones, such as 1-(4-tert.-butylphenyl)-3-(4′-methoxyphenyl)-propane-1,3-dione; and ketotricyclo(5.2.1.0)decane derivatives. Other suitable compounds are 2-phenylbenzimidazole-5-sulfonic acid and its alkali, alkaline earth, ammonium, alkylammonium, alkanolammonium and glucammonium salts; sulfonic acid derivatives of benzophenones, preferably 2-hydroxy-4-methoxybenzophenone-5-sulfonic acid and its salts; sulfonic acid derivatives of 3-benzylidinecamphor, such as 4-(2-oxo-3-bornylidenemethyl)benzenesulfonic acid and 2-methyl-5-(2-oxo-3-bornylidene)sulfonic acid and their salts.

Derivatives of benzoylmethane in particular are considered as typical UV-A filters, such as 1-(4′-tert.-butylphenyl)-3-(4′-ethoxyphenyl)propane-1,3-dione, 4-tert.-butyl-4′-methoxydibenzoylmethane (Parsol 1789), 1-phenyl-3-(4′-isopropylphenyl)-propane-1,3-dione and enamine compounds. The UV-A and UV-B filters can, obviously, also be used in mixtures. Aside from the soluble substances named, insoluble light-protective pigments, i.e. finely disperse, preferably nanoized metal oxides or salts can be considered for this purpose. Examples of suitable metal oxides are, in particular, zinc oxide and titanium dioxide, as well as oxides of iron, zirconium, silicon, manganese, aluminum and cerium, and mixtures of them. Silicates (talc), barium sulfate or zinc stearate can be used as salts. The oxides and salts are already in use as pigments for skin-care and skin-protection emulsions and decorative cosmetics. The particles should have a mean diameter of less than 100 nm, preferably 5 to 50 nm, and particularly 15 to 30 nm. They can have a spherical shape, however, it is also possible to use particles that are ellipsoidal or have forms otherwise differing from the spherical shape. The pigments can also be surface-treated, i.e., hydrophilized or hydrophobized. Typical examples are coated titanium dioxides such as Titandioxid T 805 (Degussa) or Eusolex® T2000 (Merck). Silicones, particularly trialkyloxyoctylsilane or simethicone are particularly considered as hydrophobic coating agents. Micronized zinc oxide is used preferably. Other suitable UV light-protective filters can be found at the applicable state of the art.

The agents comprise the UV absorbers advantageously in proportions of 0.01% by weight to 5% by weight, preferably from 0.03% by weight to 1% by weight. They can also be added to the agents later, for instance, along with other substances.

It is preferable for the agents according to the invention, if they are solid, to be tablets or moldings, as was pointed out earlier. In the context of the present invention, “tablets” or “moldings” are solid bodies of stable shape, whatever the manner of their production. Such bodies can be produced, for instance, by crystallization, casting, injection molding, reactive or thermal sintering, (co)extrusion, prilling, pastilling, or compacting processes such as calendering or tabletting. Production of the “tablets” or “moldings” by tabletting is particularly preferred in the context of the present invention. Thus the tablet consists preferably of pressed particulate material.

Solid agents according to the invention, preferably being tablets or moldings, can preferably comprise disintegrants. Bentonites or other swellable silicates, for example, can be considered as swellable disintegrants. Synthetic polymers can also be used, especially the superabsorbers used in the hygiene area or cross-linked polyvinylpyrrolidone.

It is particularly advantageous to use swellable distintegrant polymers based on starch or cellulose. These basic substances can be used alone or processed into mixtures of other natural and/or synthetic polymers as swellable disintegrants. In the simplest case, a cellulose-containing material or pure cellulose can be transformed by granulation, compacting or other application of pressure into secondary particles that swell on contact with water and so act as disintegrants. Wood is a proven cellulose-containing material that is accessible from wood or wood pieces (sawdust, sawmill wastes) by thermal or chemical-thermal processes. This cellulose material from the TMP (thermo mechanical pulp) or CTMP (chemo thermo mechanical pulp) process can be compacted by application of pressure, preferably roll-compacted, and converted to particulate form. Obviously pure cellulose can be used in quite the same way, although it is a more expensive raw material. Both microcrystalline and amorphous finely divided celluloses, and mixtures of them, can be used here.

Another way consists of granulating the cellulose-containing material with addition of granulating aids. For example, solutions of synthetic polymers or of nonionic surfactants have been proven as granulating aids. To avoid residues on the textiles washed with the agents according to the invention, the primary fiber length of the cellulose used, or of the cellulose in the cellulose-containing material, should be less than 200 μm, with primary fiber lengths of less than 100 μm, and especially those of less than 50 μm, preferred.

The secondary particles ideally have a particle size distribution in which it is preferable for more than 90% by weight of the particles to have sizes greater than 200 μm. A certain proportion of dust can contribute to improved storage stability of the tablets produced with it. Fine dust proportions of less than 0.1 mm up to 10% by weight, preferably up to 8% by weight, can be present in the agents used according to the invention.

The agent according to the invention can also be in the form of a conditioner and/or conditioner substrate and comprise the appropriate ingredients. The term “conditioning” is to be understood preferably in the sense of this invention as the treatment to give textiles, materials and cloths softness and suppleness. Conditioning gives the textiles favorable properties, such as a better hand, increased gloss and color brilliance, improved odor impression, reduction of felting, easier ironing due to reduction of sliding characteristics, reduction of creasing and of static charging, and inhibition of color transfer for dyed textiles.

The agent according to the invention can have softening components to improve the hand and the softness and suppleness properties. Examples of such compounds are quaternary ammonium compounds, cationic polymers, and emulsifiers such as are used in hair-care agents as well as in agents for making textiles supple. These softening compounds, which will also be described in more detail below, can be contained in all the agents according to the invention, but especially in the conditioning agents or in agents intended to have softening action.

Suitable examples are quaternary ammonium compounds of formulas (III) and (IV),

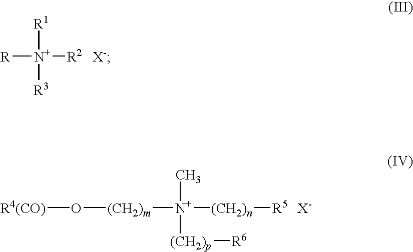

in which R and R¹ in (III) stand for an acyclic alkyl group with 12 to 24 carbon atoms, R² stands for a saturated C₁-C₄ alkyl or hydroxyalkyl group, and R³ is either identical to R, R¹ or R², or stands for an aromatic group. X stands either for a halide, methosulfate, methophosphate or phosphate ion, or mixtures of those. Examples of cationic compounds of formula (III) are didecyldimethylammonium chloride, ditallow-dimethylammonium chloride or dihexadecylammonium chloride

Compounds of formula (IV) are called “esterquats”. Esterquats are distinguished by outstanding biodegradability. Here R⁴ stands for an aliphatic alkyl group with 12 to 22 carbon atoms, with 0, 1, 2 or 3 double bonds; R⁵ stands for H, OH, or O(CO)R⁷, R⁶, independently of R⁵, stands for H, OH or O(CO)R⁸, in which R⁷ and R⁸, independently of each other, each stand for an aliphatic alk(en)yl group having 12 to 22 carbon atoms with 0, 1, 2 or 3 double bonds. Independently of each other, m, n and p can each have the value 1, 2 or 3. X⁻ can be either a halide, methosulfate, methophosphate, or phosphate ion or mixtures of them. Compounds which contain the group O(CO)R⁷ for R⁵ sand alkyl groups with 16 to 18 carbon atoms for R⁴ and R⁷ are preferred. Compounds in which R⁶ stands for OH are particularly preferred. Examples of compounds of formula (IV) include methyl-N-(2-hydroxyethyl)-N,N-ditallow-acyloxyethyl)ammonium methosulfate, bis-(palmitoyl)-ethyl-hydroxyethylmethylammonium methosulfate or methyl-N,N-bis(acyl-oxyethyl)-N-(2-hydroxyethyl)-ammonium methosulfate. If quaternized compounds of formula (IV) are used, which contain unsaturated alkyl chains, preferred acyl groups are those for which the corresponding fatty acids have iodine values between 5 and 80, preferably between 10 and 60, and especially between 15 and 45, and which have a cis/trans isomer ratio (in % by weight) greater than 30:70, preferably greater than 50:50 and especially greater than 70.30. Common commercial examples are the methylhydroxyalkyldialkoyloxy-alkylammonium methosulfates marketed by Stepan under the Stepantexe tradename, or the Cognis products known as Dehyquart® or the Goldschmidt-Witco products known as Rewoquat®. The diesterquats of formula (V), which are available under the names Rewoquat® W 222 LM or CR 3099 and which provide not only softness but also stability and color protection are other preferred compounds.

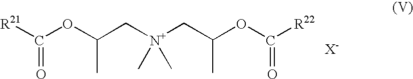

Here R²¹ and R²² independently of each other, each stand for an aliphatic group having 12 to 22 carbon atoms with 0, 1 2 or 3 double bonds.

Other known compounds than the quaternary compounds described above can also be used, such as quaternary imidazolinium compounds of formula (VI),

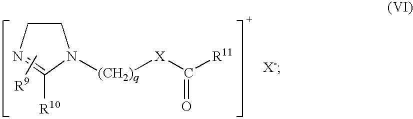

in which R⁹ can stand for H or for a saturated alkyl group having 1 to 4 carbon atoms, R¹⁰ and R¹¹, independently of each other, can each stand for an aliphatic, saturated or unsaturated alkyl group with 12 to 18 carbon atoms, R¹⁰ can, alternatively, also stand for O(CO)R²⁰, where R²⁰ means an aliphatic, saturated or unsaturated alkyl group with 12 to 18 carbon atoms, and Z means a NH group or oxygen, and X⁻ is an anion, and q can have integral values between 1 and 4.

Other suitable quaternary compounds are described by formula (VII),

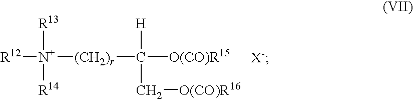

in which R¹², R¹³, and R⁴, independently of each other, stand for a C₁₋₄-alkyl, alkenyl, or hydroxyalkyl group, R¹⁵ and R¹⁶, each selected independently represent a C₈₋₂₈-alkyl group and r is a number between 0 and 5.

Along with the compounds of formulas (III) and (IV), short-chain water-soluble quaternary ammonium compounds can also be used, such as trihydroxyethylmethylammonium methosulfate or the alkyltrimethylammonium chlorides, dialkyldimethylammonium chlorides and trialkylmethylammonium chlorides, such as cetyltrimethylammonium chloride, stearyltrimethylammonium chloride, distearyldimethyammonium chloride, lauryidimethylammonium chloride, lauryldimethylbenzylammonium chloride and tricetylmethylammonium chloride.

Protonated alkylamine compounds that exhibit softening action, and the non-quaternized protonated precursors of the cationic emulsifiers are also suitable.

The quaternized protein hydrolyzates are also cationic compounds that are usable according to the invention.

The suitable cationic polymers include the polyquaternium polymers such as are listed in the CFTA Cosmetic Ingredient Dictionary (The Cosmetic, Toiletry and Fragrance, Inc., 1997), especially polyquaternium-6, polyquaternium-7, and polyquaternium-10 polymers also known as Merquats (Ucare Polymer IR 400; Amerchol), polyquaternium-4 copolymers, such as graft copolymers with a cellulose skeleton and quaternary ammonium groups bound through allyldimethylammonium chloride, cationic cellulose derivatives such as cationic guar, such as guar-hydroxypropyltriammonium chloride and similar quaternized guar derivatives (e.g., Cosmedia Guar, made by Cognis GmbH), cationic quaternary sugar derivatives (cationic alkylpolyqlucosides), such as the commercial product Glucquat® 100, which is a “lauryl methyl gluceth-10 hydroxypropyl dimoniumchloride” according to CTFA nomenclature, copolymers of PVP and dimethylaminomethacrylate, copolymers of vinylimidazole and vinylpyrrolidone, aminosilicone polymers and copolymers.

Polyquaternized polymers (e.g., Luviquat Care from BASF) are also usable, as well as chitin-based cationic biopolymers and their derivatives, such as the polymer available under the tradename Chitosan® (made by Cognis).

Cationic silicone oils such as the products Q2-7224 (manufacturer: Dow Corning; a stabilized trimethylsilylaminodimethicone), Dow Corning 929 Emulsion (containing a hydroxyl-amino modified silicone, also known as Amodimethicone), SM2059 (manufacturer: General Electric), SLM-55067 (manufacturer: Wacker), Abil®-Quat 3270 and 3272 (manufacturer: Goldschmidt-Rewo; diquaterary polydimethylsiloxane, quaternium-80) and Siliconquat Rewoquat® SQ 1 (Tegopren® 6922, manufacturer: Goldschmidt-Rewo) are also usable according to the invention.

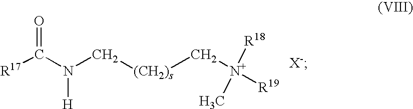

Compounds of formula (VIII), which represents alkylamidoamines in their non-quaternized form or, as shown, in their quaternized form, are also usable. R¹⁷ can be an aliphatic alk(en)yl group with 12 to 22 carbon atoms with 0, 1, 2 or 3 double bonds and s can take values between 0 and 5. R¹⁸ and R¹⁹, independently of each other, each stand for H, C₁₋₄ alkyl or hydroxyalkyl. Preferred compounds are fatty acid amidoamines such as the stearylamidopropyldimethylamine available as Tego Amide S18 or the 3-tallow-amidopropyltrimethylammonium methosulfate available as Stepantex® X9124. They are distinguished by not only good conditioning action but also by inhibition of color transfer and, in particular, by their good biodegradability.

Alkylated quaternary ammonium compounds in which at least one alkyl chain is interrupted by an ester group and/or an amido group are specially preferred, particularly N-methyl-N-(2-hydroxyethyl)-N,N-(ditallowacyloxyethyl)-ammonium methosulfate.

Nonionic softeners for special consideration include polyoxyalkylene glycerol alkanoates, polybutylene, long-chain fatty acids, ethoxylated fatty acid ethanolamides, alkylpolyglycosides, especially sorbitan mono, di and tri esters and fatty acid esters of polycarboxylic acids.

An agent according to the invention, preferably a conditioning agent, can contain softeners in proportions of 0.1 to 80% by weight, usually 0.1 to 70% by weight, preferably 0.2 to 60% by weight and especially 0.5 to 40% by weight, based in each case on the complete agent.

Conditioning agents according to the invention can preferably comprise one or more anionic surfactants, especially those which were described above.

Conditioning agents according to the invention can preferably comprise one or more nonionic surfactants, especially those which were described above.

The so-called Gemini surfactants can be considered as other surfactants for all agents according to the invention. This generally means compounds that have two hydrophilic groups and two hydrophobic groups per molecule. These groups are, as a rule, separated from each other by a so-called “spacer”. This spacer is generally a carbon chain, which should be long enough that the hydrophobic groups are separated sufficiently that they can act independently of each other. Such surfactants are generally distinguished by an unusually high critical micelle concentration and the ability to reduce the surface tension of water strongly. In exceptional cases, though, the expression Gemini surfactants is understood to mean not only dimeric but also trimeric surfactants.

Suitable Gemini surfactants are, for example, sulfated hydroxy mixed ethers or dimeralcohol bis and trimer alcohol tris sulfates and ether sulfates. End-group capped dimeric and trimeric mixed ethers are particularly distinguished by their bifunctionality and multifunctionality. Thus the end-group-capped surfactants have good wetting properties and are low-foaming, so that they are particularly suitable for use in machine washing or cleaning processes.

However, Gemini polyhydroxyfatty acid amides or poly-polyhydroxy-fatty acid amides such as are described at the applicable state of the art can also be used.

Other suitable surfactants are polyhydroxy fatty acid amides of the following formula:

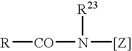

in which the RCO stands for an aliphatic acyl group with 6 to 22 carbon atoms, R²³ stands for hydrogen, an alkyl or hydroxyalkyl group with 1 to 4 carbon atoms, and [Z] stands for a linear or branched polyhydroxyalkyl group with 3 to 10 carbon atoms and 3 to 10 hydroxyl groups. The polyhydroxyfatty acid amides are known substances which are can usually be obtained by reductive amination of a reducing sugar, an alkylamine, or an alkanolamine and subsequent acylation with a fatty acid, a fatty acid alkyl ester, or a fatty acid chloride.

The group of polyhydroxyfatty acid amides also includes compounds of the following formula:

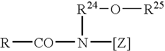

in which R stands for a linear or branched alkyl or alkenyl group having 7 to 12 carbon atoms, R²⁴ for a linear, branched or cyclic alkyl group or an aryl group or an oxyaryl group with 2 to 8 carbon atoms, with C₁₋₄-alkyl groups or phenyl groups preferred, and [Z] stands for a linear polyhydroxyalkyl group, the alkyl chain of which is substituted with at least two hydroxyl groups, or alkoxylated, preferably ethoxylated or propoxylated derivatives of that group.

[Z] is preferably obtained by reductive amination of a reducing sugar, such as glucose, fructose, maltose, lactose, galactose, mannose or xylose. Then the N-alkoxy or N-aryloxy substituted compounds can be converted into the desired polyhydroxyfatty acid amides by reaction with fatty acid methyl esters in the presence of an alkoxide as the catalyst.

The agents according to the invention preferably also contain amphoteric surfactants. Aside from numerous singly to triply alkylated amino oxides, the betaines are a significant class.

Betaines are known surfactants that are produced predominantly by carboxyalkylation, preferably carboxymethylation, of amine compounds. Preferably the starting materials are condensed with halocarboxylic acids or their salts, especially with sodium chloroacetate, forming one mole of salt per mole of betaine. It is also possible to add unsaturated carboxylic acids such as acrylic acid. See the applicable technical literature on the nomenclature and particularly on the distinction between betaines and “true” amphoteric surfactants. Examples of suitable betaines include the carboxyalkylation products of secondary and, in particular, tertiary alcohols which have the formula (IX):

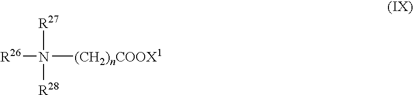

in which the R²⁶ stands for alkyl and/or alkylene groups having 6 to 22 carbon atoms, R²⁷ stands for hydrogen or an alkyl group having 1 to 4 carbon atoms, R²⁸ stands for alkyl groups with 1 to 4 carbon atoms, n stands for numbers from 1 to 6 and X¹ stands for an alkali and/or alkaline earth metal or ammonium. Typical examples are the carboxymethylation products of hexyl methyl amine, hexyl dimethyl amine, octyl dimethyl amine, decyl dimethyl amine, dodecyl methyl amine, dodecyl dimethylamine, dodecyl ethyl methylamine, C_{12/14}-cocoalkyl dimethyl amine, myristyl dimethyl amine, cetyl dimethyl amine, stearyl dimethyl amine, stearyl ethyl methyl amine, oleyl dimethyl amine, C_{16/18} tallow alkyl dimethyl amine and their industrial mixtures.

One can also consider carboxylakylation products of amidoamines having the formula (X):

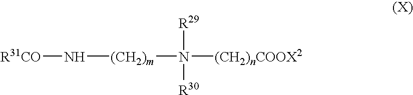

in which R³¹CO stands for an aliphatic acyl group with 6 to 22 carbon atoms and 0 or 1 to 3 double bonds, m stands for numbers from 1 to 3, and R²⁹, R³⁰, n and X² have the meanings given above. Typical examples are reaction products of fatty acids having 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselinic acid, linoleic acid, linolenic acid, eleostearic acid, arachidic acid, gadolinic acid, behenic acid and erucic acid as well as their industrial mixtures, with N,N-dimethylamino-ethylamine, N,N-dimethylaminopropylamine, N,N-diethylaminoethylamine and N,N-diethylaminopropylamine, which are condensed with sodium chloroacetate. It is preferable to use a condensation product of C_{8/18}-coco fatty acid-N,N-dimethylaminopropylamide with sodium chloroacetate.

Other suitable starting materials for the betaines that are usable in the sense of the invention are imidazolines, which have the formula (XI):

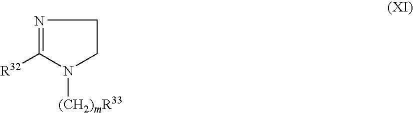

in which the R³² stands for an alkyl group with 5 to 21 carbon atoms, R³³ for a hydroxyl group, an OCOR³² or NHCOR³² group, and m for 2 or 3. These substances are also known materials which can be obtained, for example, by cyclizing condensation of 1 or 2 moles of fatty acid with multifunctional amines such as aminoethyl ethanolamine (AEAA) or diethylenetriamine. The corresponding carboxyalkylation products are mixtures of various open-chain betaines. Typical examples are condensation products of the fatty acids named above with AEEA, preferably imidazolines based on lauric acid or, again, C_{12/14}-coco fatty acids which are then betainized with sodium chloroacetate.

In a preferred embodiment, the agents according to the invention occur in liquid form, as previously presented, for instance, in the form of conditioning agents or liquid washing agents. Use of liquid organic solvents, as well as of water, is indicated to attain a fluid consistency. Thus the agents according to the invention optionally comprise solvents.

Solvents that can be used in the agents according to the invention are derived, for example, from the groups of monofunctional or multifunctional alcohols, alkanolamines or glycol ethers, to the extent that they are miscible with water in the given concentration range. The solvents are preferably selected from ethanol, n-propanol or i-propanol, butanols, glycol, propanediol or butanediol, glycerol, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl, or propyl ether, butoxy-propoxy-propanol (BPP), dipropylene glycol monomethyl or ethyl ether, di-isopropylene glycol monomethyl or ethyl ether, methoxy, ethoxy or butoxy triglycol, i-butoxyethoy-2-propanol, 3-methyl-3-methoxybutanol, propylene glycol t-butyl ether and mixtures of those solvents.

Some glycols can be obtained under the tradenames Arcosolv®, (Arco Chemical Co.) or Cellosolve® or Propasol® (Union Carbide Corporation) Those also include, for example, ButylCarbitol®, HexylCarbitol®, MethylCarbitol®, and Carbitol® itself, (2-(2-ethoxy)ethoxy)ethanol). One skilled in the art can easily make the selection of the glycol ether on the basis of its volatility, its water solubility, its percentage by weight in the complete composition, and the like. Pyrrolidone solvents such as N-alkyl-pyrrolidones e.g. N-methyl-2-pyrrolidone or N—C₈-C₁₂-pyrrolidone, or 2-pyrollidone, can also be used. Glycerin derivatives, especially glycerin carbonate, are also preferred as the sole solvent or as a component of a solvent mixture.

The alcohols used preferably as cosolvents in the present invention include liquid polyethylene glycols with low molecular weight, such as polyethylene glycols having molecular weights of 200, 300, 400 or 600. Other suitable solvents are other alcohols, such as (a) lower alcohols such as ethanol, propanol, isopropanol and n-butanol; (b) ketones such as acetone and methyl ethyl ketone, (c) C₂-C₄-polyols such as a diol or a triol, for instance, ethylene glycol, propylene glycol, glycerol or mixtures of those. 1,2-octanediol is particularly preferred from the class of the diols.

In a preferred embodiment, the agent according to the invention comprises one or more solvents from the group including C₁-C₄ monoalcohols, C₂ to C₆ glycols, C₃ to C₁₂ glycol ethers and glycerol, especially ethanol. The C₃ to C₁₂ glycols ethers according to the invention contain alkyl or alkenyl groups with fewer than 10 carbon atoms, preferably up to 8, especially up to 6, particularly preferably 1 to 4 and extremely preferably 2 to 3 carbon atoms.

Preferred C₁ to C4 monoalcohols are ethanol, n-propanol, iso-propanol and tert-butanol. Preferred C₂ to Ce glycols are ethylene glycol, 1,2-propylene glycol, 1,3-propylene glycol, 1,5-pentanediol, neopentyl glycol and 1,6-hexanediol, especially ethylene glycol and 1,2-propylene glycol. Preferred C3 to C12 glycol ethers are di, tri, tetra and penta-ethylene glycol, di, tri and tetra-propylene glycol, propylene glycol mono-tertiary butyl ether and propylene glycol monoethyl ether, as well as the solvents, designated according to INCI, butoxydiglycol, butoxyethanol, butoxyisopropanol, butoxypropanol, butyloctanol, ethoxydiglycol, ethoxyethanol, ethyl hexanediol, isobutoxypropanol, isopentyl diol, 3-methoxybutanol, methoxyethanol, methoxyisopropanol and methoxymethyl butanol.

The agents according to the invention, preferably conditioning agents or liquid detergents, can comprise one or more solvents in a proportion of usually up to 40% by weight, preferably 0.1 to 30% by weight, especially 2 to 20% by weight, especially preferably 3 to 15% by weight, extremely preferably 5 to 12% by weight, such as 5.3 or 10.6% by weight, based in each case on the complete agent.

In a preferred embodiment, the agent according to the invention, such as a conditioner in particular, can optionally comprise one or more complexing agents.

Complexing agents (INCI Chelating agents), also called sequestering agents, are ingredients that can complex and inactivate metal ions, for example, to prevent their harmful effects on the stability of appearance of the agent, especially clouding. It is important to complex the calcium and magnesium ions of the water hardness that are incompatible with many ingredients. Complexing of ions of heavy metals, such as iron or copper, delays the oxidative decomposition of the finished agent.

For example, the following complexing agents, named according to INCI, are suitable. They are described in more detail in the International Cosmetic Ingredient Dictionary and Handbook: aminotrimethylene phosphonic acid, beta-alanine diacetic acid, calcium disodium EDTA, citric acid, cyclodextrin, cyclohexanediamine tetraacetic acid, diammonium citrate, diammonium EDTA, diethylenetriamine pentamethylene phosphonic acid, dipotassium EDTA, disodium azacycloheptane diphosphonate, disodium EDTA, disodium pyrophosphate, EDTA, Etidronic acid, galactaric acid, gluconic acid, glucuronic acid, HEDTA, hydroxypropyl cyclodextrin, methyl cyclodextrin, pentapotassium triphosphate, pentasodium aminotrimethylene phosphonate, pentasodium ethylenediamine tetramethylene phosphonate, pentasodium pentetate, pentasodium triphosphate, pentetic acid, phytic acid, potassium citrate, potassium EDTMP, potassium gluconate, potassium polyphosphate, potassium tris-phosphonomethylamine oxide, ribonic acid, sodium chitosan methylene phosphonate, sodium citrate, sodium diethylenetriamine pentamethylene phosphonate, sodium dihydroxyethyl glycinate, sodium EDTMP, sodium gluceptate, sodium gluconate, sodium glycereth-1 polyphosphate, sodium hexametaphosphate, sodium metaphosphate, sodium metasilicate, sodium phytate, sodium polydimethylgycinophenolsulfonate, sodium trimetaphosphate, TEA-EDTA, TEA-polyphosphate, tetrahydroxyethyl ethylenediamine, tetrahydroxypropyl ethylenediamine, tetrapotassium etidronate, tetrapotassium pyrophosphate, tetrasodium EDTA, tetrasodium etidronate, tetrasodium pyrophosphate, tripotassium EDTA, trisodium dicarboxymethyl alaninate, trisodium EDTA, trisodium HEDTA, trisodium NTA and trisodium phosphate.

Tertiary amines are preferred complexing agents, especially tertiary alkanolamines (aminoalcohols). The alkanolamines have both amino and hydroxy and/or ether groups as functional groups. Especially preferred tertiary alkanolamines are triethanolamine and tetra-2-hydroxypropylethylenediamine (N,N,N′,N′-tetrakis-(2-hydroxypropyl)ethylenediamine). Particularly preferred combinations of tertiary amines with zinc ricinoleate and one or more ethoxylated fatty alcohols as nonionic solubilizers or optionally solvents are described at the state of the art.

Etidronic acid (1-hydroxyethylidene-1,1-diphosphonic acid, 1-hydroxyethane-1,1-diphosphonic acid, HEDP, acetophosphonic acid, INCI Etidronic acid), including its salts, is a particularly preferred complexing agent. In a preferred embodiment the agent according to the invention accordingly comprises etidronic acid and/or one or more of its salts as complexing agents.

In a special embodiment, the agent according to the invention comprises a combination of complexing agents of one or more tertiary amines and one or more other complexing agents, preferably one or more complexing acids or their salts, especially of triethanolamine and/or tetra-2-hydroxypropy-lethylenediamine and editronic acid and/or one or more of their salts.

In a further embodiment the agent according to the invention, such as conditioners in particular, optionally comprises one or more viscosity regulators which preferably act as thickeners.

The viscosity of the agent can be measured with the usual standard methods (such as the Brookfield Viscosimeter RVD-VII at 20 rpm and 20° C., spindle 3). Preferred liquid to gel-like agents can exhibit viscosities of 20 to 4000 mPas, in which range values of 40 to 2000 mPas can be particularly preferred.

Inorganic or polymeric organic compounds are suitable thickeners. Mixtures of more than one thickener can also be used.

The inorganic thickeners include, for example, polysilicic acids, or clay minerals such as montmorillonites, zeolites, silicic acids, aluminum silicates, lamellar silicates and bentonites.

The organic thickeners are derived from the groups of natural polymers, modified natural polymers, and completely synthetic polymers.

Polymers of natural origin used as thickeners include, for example, xanthan, agar-agar, carrageenan, tragacanth, gum arabic, alginates, pectins, polyoses, guar meal, gellan gum, carob bean meal, starches, dextrins, gelatines and casein.

Modified natural products are derived principally from the group of modified starches and celluloses, such as carboxymethylcellulose and other cellulose ethers, hydroxyethylcellulose and hydroxypropylcellulose, highly etherified methylhydroxyethylcellulose and seed meal ethers.

The completely synthetic polymers such as polyacrylic and polymethacrylic compounds are a large group of thickeners that are widely used in quite varied applications. They can be crosslinked or uncrosslinked, and optionally cationically modified, vinyl polymers, polycarboxylic acids, polyethers, activated polyamide derivatives, castor oil derivatives, polyimines, polyamides and polyurethanes. Examples of such polymers include acrylic resins, ethyl acrylate-acrylamide copolymers, acrylic acid ester-methacrylic acid ester copolymers, ethyl acrylate-acrylic acid-methacrylic acid copolymers, N-methylolmethacrylamide, maleic anhydride-methylvinyl ether copolymers, polyether-polyol copolymers and butadiene-styrene copolymers.

Other suitable thickeners are derivatives of organic acids such as their alkoxide adducts, for example, arylpolyqlycol ethers, carboxylated nonylphenolethoxylate derivatives, sodium alginate, diglycerol monoisostearate, nonionic ethylene oxide adducts, coco fatty acid diethanolamide, isododecenylsuccinic acid anhydride and galactomannan. Thickeners of the substance classes named are commercially available and are offered, for example, under the tradenames Acusol®-820 (methacrylic acid (stearyl alcohol-20-EO) ester-acrylic acid copolymer, 30% in water, Rohm & Haas), Dapral®-GT-282-S (alkylpolyglycol ether, Akzo), Deuterol® Polymer-11 (dicarboxylic acid copolymer, Schöner GmbH, Deuteron®-XG (anionic hereropolysaccharide based on β-D-glucose, D-mannose, D-glucuronic acid, Schöner GmbH, Deuteron®-XN (nonionic polysaccharide, Schöner GmbH), Dicrylan®-Thickener-O (ethylene oxide adduct, 50% in water/isopropanol, Pfersse Chemie), EMA®-81 and EMA®-91 (ethylene maleic anhydride copolymer, Monsanto), Thickener-QR-1001 (polyurethane emulsion, 19-21% in water/diglycol ether, Rohm & Haas), Mirox®-AM anionic acrylic acid-acrylic acid ester copolymer dispersion, 25% in water, Stockhausen), SER-AD-FX-1100 (hydrophobic urethane polymer, Servo Delden), Shellflo®-S (high-molecular-weight polysaccharide, stabilized with formaldehyde, Shell), Shellflo®-XA (xanthan biopolymer, stabilized with formaldehyde, Shell), Keizan, and Keltrol T (Kelco).

In a further preferred embodiment, the agent according to the invention, especially a conditioner, optionally comprises one or more enzymes.

Enzymes that may be considered include in particular those of the classes of hydrolases, such as the proteases, esterases, lipases or enzymes with lipolytic action, amylases, cellulases or other glycosylhydrolases, and mixtures of those enzymes. In the laundry, all these hydrolases contribute to removal of spots such as proteinaceous, fatty, or starch-containing spots and discolorations. Cellulases and other glycosylhydrolases can further contribute to maintaining the color and increasing the softness of the textile by removing pilling and microfibrils. Oxidoreductases can also be used to bleach or to inhibit color transfer.

Enzymatically active substances obtained from bacterial strains or fungi such as Bacillus subtilis, Bacillus lichenformis, Streptomyces griseus and Humicola insolens are particularly suitable. Proteases of the subtilisin type and, in particular, proteases obtained from Bacillus lentus, are used preferably. Enzyme mixtures are of particular interest, such as mixtures of proteases and amylases or proteases and lipases or enzymes with lipolytic action or proteases and cellulases or cellulases and lipases or enzymes with lipolytic action, or mixtures of proteases, amylases and lipases or enzymes with lipolytic action, lipases or enzymes with lipolytic action and cellulases, but especially mixtures of proteases and/or lipases or mixtures with enzymes having lipolytic action. Examples of such enzymes with lipolytic action are the well-known cutinases. Peroxidases or oxidases have also proven suitable in some cases. The suitable amylases include in particular α-amylases, isoamylases, pullulanases and pectinases. Cellobiohydrolases, endoglucanases and β-glucosidases, also called cellobiases, or mixtures of them, are used preferably as cellulases. As various cellulase types differ in their CMCase and Avicalase activities, the desired activities can be adjusted by careful mixtures of the cellulases.

The enzymes can be adsorbed to carriers as molded or embedded coated to protect them from premature denaturation. The proportion of enzymes, enzyme mixtures or enzyme granulations can, for example, be about 0.1 to 0.5% by weight, preferably 0.12 to about 2% by weight, based on the complete agent. The agents according to the invention, such as, in particular, detergents and cleaners, care agents or conditioning agents, can contain bleaching agents. Of the compounds that serve as bleaches, and provide H₂O₂ in water, sodium percarbonate, sodium perborate tetrahydrate and sodium perborate monohydrate are of particular importance. Other usable bleaches are, for example, peroxopyrophosphate, citrate perhydrate, and peracids or peracid salts that provide H₂O₂, such as persulfates or persulfuric acid. The urea peroxohydrate Percabamide, which can be described by the formula H₂N—CO—NH₂.H₂O₂, is also usable. In particular, of the agents are to be used to clean hard surfaces, such as in machine dishwashing rinses, they can if desired also contain bleaches from the group of organic bleaches, although they can be used principally in laundry detergents. Typical organic bleaches are the diacyl peroxides, such as dibenzoyl peroxide. Other typical organic bleaching agents that can be used are the peroxyacids, with the alkyleroxyacids and the arylperoxyacids particular examples. Preferred representatives are peroxybenzoic acid and its ring-substituted derivatives, such as alkylkperoxybenzoic acids, as well as peroxy-α-naphthoic acid and magnesium monoperphthalate, the aliphatic or substituted aliphatic peroxyacids such as peroxylauric acid, peroxystearic acid, ε-phthalimido-peroxycaproic acid (phthalimidoperoxyhexanoic acid, PAP), o-carboxy-benzamidoperoxycaprpic acid, N-nonenylamidoperadipic acid and N-nonenylamidopersuccinate, and aliphatic and araliphatic peroxydicarhoxylic acids such as 1,12-diperoxycarboxylic acid, 1,9-diperoxyazelaic acid, diperoxysebacic acid, diperoxybrassylic acid, the diperoxyphthalic acids, 2-decyl-diperoxy-butane-1,4-dicarboxylic acid, and N,N-terephthaloyl-di-(6-aminopercaproic acid).

Dyes can be used in the agent according to the invention. The proportion of one or more dyes must be selected so low that no visible residues remain after use of the agent. The agent according to the invention is preferably free of dyes.

The agent according to the invention can preferably comprise one or more antimicrobial substances or preservatives in a proportion of usually 0.0001 to 3% by weight, preferably 0.0001 to 2% by weight, especially 0.0002 to 1% by weight, but especially preferably 0.0002 to 0.2% by weight, most preferably 0.0003 to 0.1% by weight.

One distinguishes the antimicrobial substances or preservatives between bacteriostats and bactericides, fungistats and fungicides, etc., according to their antimicrobial spectrum and mechanism of action. Benzalkonium chloride, alkylarylsulfonates, halophenols and phenylmercuric acetate are examples of important substances of this group. The concepts of antimicrobial action and antimicrobially active substance have the usual technical meanings in the teaching according to the invention. Suitable antimicrobially active substances are preferably selected from the groups of alcohols, amines, aldehydes, antimicrobial acids or their salts, carboxylic acid esters, acid amides, phenols, phenol derivatives, biphenyls, diphenylalkanes, urea derivatives, oxygen acetals or formals, nitrogen acetals or formals, benzamidines, isothiazolines, phthalimide derivatives, pyridine derivatives, antimicrobially surface-active compounds, guanidines, antimicrobially amphoteric compounds, quinolines, 1,2-dibromo-2,4-dicyanobutane, iodo-2-propylbutyl carbamate, iodine, iodophores, peroxo compounds, halogen compounds and arbitrary mixtures of the above.

The antimicrobial substance can be selected from ethanol, n-propanol, iso-propanol, 1,3-butanediol, phenoxyethanol, 1,2-propylene glycol, glycerol, undecylenic acid, benzoic acid, sailcylic acid, dehydroacetic acid, o-phenylphenol, N-methylmorpholinoacetonitrile (MMA), 2-benzyl-4-chlorohenol, 2,2′-methylene-bis-(6-bromo-4-chlorophenol), 4,4′-dichloro-2′-hydroxydiphenyl ether (Dichlosan), 2,4,4′-trichloro-2′-hydroxydiphenyl ether (Trichlosan), chlorhexidine, N-(4-chlorophenyl)-N-(3,4-dichlorophenyl)-urea, N,N′-(1,10-decan-diyl-1-pyridinyl-4-ylidene)-bis-(1-octanamine) dihydrochloride, N,N′-bis-(4-chlorophenyl)-3,12-diimino-2,4,11,13-tetraazatetradecane diimide amide, glucoprotamines, antimicrobially surface-active quaternary compounds, guanidines including the biguanidines and polyguanidines, such as 1,6-bis-(2-ethylhexyl-biguanidohexane) dihydrochloride, 1,6-di(N₁, N₁′-phenyldiguanido-N₅, N₅′)-hexane tetrahydrochloride, 1,6-di(N₁, N₁′-phenyl-N₁,N₁-methylguanido-N₅, N₅′)-hexane dihydrochloride, 1,6-di-(N₁,N₁′-o-chlorophenyldiguanido-N₅,N₅′)-hexane dihydrochloride, 1,6-di(N₁,N₁′-2,6-dichlorophenyldiguanido-N₅,N₅′)-hexane dihydrochloride, 1,6-di-[N₁,N₁′-beta-(p-methoxyphenyl)-diguanido-N₅,N₅′)-hexane dihydrochloride, 1,6-di(N₁, N₁′-alpha-methyl-beta-phenyldiguanido-N₅,N₅′)-hexane dihydrochloride, 1,6-di(N₁, N₁′-p-nitrophenyldiguanido-N₅,N₅′)-hexane dihydrochloride, omega:omega-di-(N₁,N₁′-phenyldiguanido-N₅,N₅′)-di-n-propyl ether dihydrochloride, 1,6-di-(N₁,N₁′-2,4-dichlorphenyldiguanido-N₅,N₅′)-hexane tetrahydrochloride, 1,6-di(N₁,N₁′-p-methylphenyldiguanido-N₅,N₅′)-hexane dihydrochloride, 1,6-di-(N₁,N₁′-2,4,5-trichlorophenylguanido-N₅,N₅′)-hexane tetrahydrochloride, 1,6-d[N₁,N₁′-alpha-(p-chlorophenyl)-ethyldiguanido-N₅,N₅′)-hexane dihydrochloride, omega:omega-di-(N₁,N₁′-p-chlorophenyldiguanido-N₅,N₅′)-m-xylene dihydrochloride, 1,12-di(N₁,N₁′-p-chlorophenyldiguanido-N₅,N₅′)-dodecane dihydrochloride, 1,10-di(N₁,N₁′-phenyldiguanido-N₅,N₅′)-decane tetrahydrochloride, 1,12-di(N₁,N₁′-phenyldiguanido-N₅,N₅′)-dodecane tetrahydrochloride, 1,6-di-(N₁,N₁′-o-chlorophenyldiguanido-N₅,N₅′)-hexane dihydrochloride, 1,6-di-(N₁,N₁′-o-chlorophenyldiguanido-N₅,N₅′)-hexane tetrahydrochloride, ethylene-bis-(1-tolylbiguanide), ethylene-bis-(p-tolylbiguanide), ethylene-bis-(3,5-dimethylphenylbiguanide), ethylene-bis-(p-tert.-amylphenylbiguanide), ethylene-bis-(nonylphenylbiguanide), ethylene-bis-(phenylbiguanide), ethylene-bis-(N-butylhenylbiguanide), ethylene-bis-(2,5-diethoxyphenylbiguanide, ethylene-bis-(2,4-dimethylphenylbiguanide), ethylene-bis-(o-diphenylbiguanide), ethylene-bis-(mixed amyl naphthyl biguanide), N-butylethylene-bis(phenylbiguanide), trimethylene-bis-(o-tolylbiguanide), N-butyltrimethylene-bis-(phenylbiguanide) and the corresponding salts such as acetate, gluconate, hydrochloride, hydrobromide, citrate, bisulfite, fluoride, polymaleate, N-coco-alkylsarcosinate, phosphite, hypophoshite, perfluorooctanoate, silicate, sorbate, salicylate, maleate, tartrate, fumarate, ethylenediaminetetraacetate, iminodiacetate, cinnamate, thiocyanate, arginate, pyromellitate, tetracarboxybutyrate, benzoate, glutarate, monofluorophosphate, perfluoropropionate and arbitrary mixtures of those. Also suitable are halogenated xylene and cresol derivatives, such as p-chloro-meta-cresol or p-chloro-metaxylene, as well as natural antimicrobially active substances of plant origin (e.g., from spices or herbs), animal origin or microbial origin. It is preferable to use antimicrobially active surface-active quaternary compounds, a natural antimicrobially active substance of plant origin and/or a natural antimicrobially active substance of animal origin, most preferably at least one natural antimicrobially active substance of plant origin from the group comprising caffeine, theobromine and theophylline and ethereal oils such as eugenol, thymol and geraniol, and/or at least one natural antimicrobially active substance of animal origin from the group comprising enzymes such as albumin from milk, lysozyme and lactoperoxidase, and/or at least one antimicrobially active surface-active quaternary compound having an ammonium, sulfonium, phosphonium, iodonium or arsonium group, peroxo compounds and chlorine compounds. Substances of microbial origin, the so-called bacteriocines, can also be used. Glycine, glycine derivatives, formaldehyde, compounds that easily release formaldehyde, formic acid and peroxide are used preferably.

The quaternary ammonium compounds (QAC) suitable as antimicrobially active substances have been described above already. For example, benzalkonium chloride, etc., is particularly suitable. Benzalkonium halides and/or substituted benzalkonium halides are commercially available, for example, as Barquat® from Lonza, Marquat® from Mason, Variquat® from Witco/Sherex and Hyamine® from Lonza, as well as Bardac® from Lonza. Other commercially available antimicrobially active substances are N-(3-chloroallyl)-hexaminium chloride such as Dowicide® and Dowicil® from Dow, benzethonium chloride such as Hyamine® 1622 from Rohm & Haas, methylbenzethonium chloride such as Hyamine® 10X from Rohm & Haas, and cetylpyridinium chloride such as Cepacol chloride from Merrell Labs.

The agents according to the invention, such as, in particular, detergents and cleaners, care agents and conditioners, can optionally contain ironing aids to improve water absorption ability and rewettability of the treated textiles, and to make ironing of the treated textiles easier. For example, silicone derivatives can be used in the formulations. These also improve the rinsing behavior of the detergent formulations through their form-inhibiting properties. Examples of preferred silicone derivatives are polydialkylsiloxanes or alkylaryisiloxanes, in which the alkyl groups have one to five C atoms and are partially or completely fluorinated. Preferred silicones are polydimethylsiloxanes, which can optionally be derivatized and can then have aminofunctional or quaternized groups or Si—OH, Si—H, and/or Si—Cl bonds. The viscosities of the preferred silicones at 25° C. are in the range of 100 to 100,000 mPas, and the silicones can be used in proportions of 0.2 to 5% by weight, based on the complete agent.

The agents according to the invention, especially conditioning agents, can be obtained according to all the current techniques known to those skilled in the art. The agents can, for instance, be obtained by direct mixing of their starting materials, optionally using high-shear mixers. For liquid formulations, especially conditioners, it is desirable to melt any softener components that may be present and then to disperse the melt in a solvent, preferably water. The polymerizable betaine esters of formula (I) that are usable according to the invention or polymers that can be prepared from them according to the invention can be integrated into the conditioner by simply mixing them in.

The conditioners are preferably soft-rinsing agents. They are usually used in the final rinse in an automatic washing machine.

A further object of the invention is a substrate, especially a conditioning substrate, which is impregnated and/or coated with an agent according to the invention, which therefore comprises the fragrance composition and oxidizing agent according to the invention.

Conditioning substrates according to the invention are used primarily in textile treatment and especially in textile drying processes. The substrate material comprises primarily porous flat pads. They can consist of a fibrous or cellular flexible material that has adequate thermal stability for use in the dryer and which can retain adequate amounts of an impregnating or coating material to condition substances effectively without occurrence of leaking or bleeding of the agent. These pads include pads of woven or nonwoven synthetic or natural fibers, felt, paper or foam, such as hydrophilic polyurethane foam.

Here it is preferable to use ordinary pads of nonwoven material (fleece). Fleeces are generally defined as adhesively bonded fibrous products with a mat or layered fiber structure, or those comprising fiber mats in which the fibers are arranged randomly or in a random arrangement. The fibers can be natural, such as wool, silk, jute, hemp, cotton, linen, sisal or ramie; or synthetic, such as rayon, cellulose esters, polyvinyl derivatives, polyolefins, polyamides or polyesters. In general, any fiber diameter or titer is suitable for the present invention. Because of the random or statistical arrangement of fibers in the nonwoven materials, which give outstanding strength in all directions, the nonwoven materials do not tend to tear or dissociate if they are used in an ordinary household washer-drier, for example. Examples of nonwoven substances that are suitable as substrates in the present invention are, for example, known from WO 93/23603. Preferred porous and flat cleaning pads comprise one or various fiber materials, especially cotton, finished cotton, polyamide, polyester, or mixtures of those. The cleaning substrates in pad form preferably have an area of 10 to 5,000 cm², preferably 50 to 2,000 cm², particularly 100 to 1500 cm² and especially preferably from 200 to 1000 cm². The weight of the material per unit area is usually between 20 and 1000 g/m², preferably 30 to 500 g/m², and especially 50 to 150 g/m². Conditioning substrates can be obtained by soaking or impregnating, or even by melting the agent or conditioning agent according to the invention onto a substrate.

A further object of the invention is use of a conditioning agent according to the invention or a conditioning substrate according to the invention in a textile conditioning process, such as a final rinsing process, a textile drying process and a textile dry-cleaning or textile refurbishing process.

Agents preferred according to the invention are liquid detergents, preferably comprising surfactant(s) as well as other usual ingredients of detergents and cleaners. For example, suitable liquid detergents can contain, as the thickener system, a) 0.1 to 5% by weight of a polymeric thickener; b) 0.5 to 7% by weight of a boron compound, and c) 1 to 8% by weight of a complexing agent.

In the context of the present invention, aqueous highly viscous liquid detergents are preferred, with surfactant concentrations greater than 35% by weight.

Suitable thickeners, also called swelling agents, such as alginates or agar-agar, have previously been described above. Preferred aqueous detergents contain as the thickener system 0.2 to 4% by weight, preferably 0.3 to 3% by weight, and particularly 0.4 to 1.5% by weight of a polysaccharide.

One polymeric thickener used preferably is xanthan, an anionic microbial heteropolysaccharide that is produced under anaerobic conditions by Xanthomonas campestris and some other species, and which has a molecular weight of 2 to 15 million Dalton. Xanthan is built up of a chain with β-1,4-linked glucoses (cellulose) with side chains. The structure of the subgroups is made up of glucose, mannose, glucuronic acid, acetate and pyruvate, with the number of pyruvate units determining the viscosity of the xanthan.

Liquid detergents according to the invention can preferably comprise a boron compound used in proportions of 0.5 to 7% by weight. Examples of boron compounds usable in the context of the present invention are boric acid, boric oxide, alkali borates such as ammonium, sodium and potassium ortho-, meta-, and pyroborates, and borax in its various hydration stages, and polyborates, such as alkali metal pentaborates.

Organic boron compounds such as esters of boric acid are also usable.

Preferred liquid detergents contain 0.5 to 4% by weight, preferably 075 to 3% by weight, and particularly 1 to 2% by weight boric acid and/or sodium tetraborate.

Liquid detergents according to the invention can also contain 1 to 8% by weight of a complexing agent. Particularly preferred liquid detergents contain citric acid or sodium citrate. Liquid detergents that contain 2.0 to 7.5% by weight, preferably 3.0 to 6.0% by weight, and especially 4.0 to 5.0% by weight sodium citrate are preferred.

Along with other ingredients, the liquid detergents according to the invention preferably contain surfactant(s), with anionic, nonionic, cationic and/or amphoteric surfactants used. From the viewpoint of applications technology, mixtures of anionic and nonionic surfactants are preferred, with the proportion of nonionic surfactant preferably greater than that of the anionic surfactants. Sugars and/or sugar derivatives such as alkyl polyglucosides or cyclodextrins can also be used.

Obviously, the liquid detergents according to the invention comprise oxidizing agents and fragrances in the manner according to the invention. This also applies to agents designated in this description as according to the invention.

### EXAMPLES

### Example 1

A liquid detergent of the following composition was prepared. Weight percentages always refer to the complete agent.

16.5% by weight linear alkylbenzenesulfonate
10% by weight C12-18 fatty alcohol+7 ethoxy units
1% by weight 1-hydroxyethane-1,1-diphosphonic acid
3% by weight sodium citrate
8% by weight sodium sulfate
3% by weight PAP granulate, based on the active substance,
0.25% by weight xanthan gum
1.3% by weight of fragrance mixture (see Example 2 or 3)
Water to make 100%.
The pH was adjusted to 5.0 by adding 50% NaOH.

### Example 2

### According to the Invention

The formulation of Example 1 was perfumed with a perfume oil comprising an fragrance in a manner according to the invention, such that more than 50% by weight of the fragrance contained was selected from fragrances that can be assigned to at least one of the following classes of materials
saturated alcohols
saturated esters
saturated ethers
aromatics with saturated substituents
nitrites
saturated acetals
saturated hemiacetals
   with the statement of weight percent in each case based on the total amount of fragrance.

### Example 3

### Comparison Example

The formulation from Example 1 was perfumed with an ordinary perfume oil II typical of detergents, comprising, among other things:

14.7% by weight iso E Super (2-acetyl-1,2,3,4,6,7,8,8A-octahydro-2,3,8,8-tetramethylnaphthalene
12.5% by weight PTBCA 25 cis (68% trans-4-tert-butylcyclohexyl acetate/32% cis-4-tert-butyl cyclohexyl acetate)
8.0% by weight dihydromyrcenol
6.0% by weight Habanolide (Oxacyclohexadecen-2-one)
5% by weight phenylethyl alcohol
3.0% by weight OTBCA (85% cis-2-tert.-butylcyclohexyl acetate/15% trans-2-tert.-butylcyclohexyl acetate)
2.0% by weight Vertofix Coeur (Wacholder, Juniperus mexicana, extract, acetylated, [3R-(3.alpha., 3a beta., 7.beta., 8a alpha.)]-1-(2,3,4,7,8,8a-hexahydro-3,6,8,8-tetramethyl-1H-3a,7-methanoazulen-5-yl)ethan-1-one)
1.5% by weight citronitril 4.0% by weight aldehyde C14 sog. (gamma-undecalactone)
16.8% by weight dipropylene glycol
12.4% by weight Lilial (2-methyl-3-(4-tert.-butylphenyl)-propionaldehyde)
4.3% by weight hexylcinnamaldehyde
2.3% by weight Bacdanol (2-ethyl-4-(2,2,3-trimethyl-3-cyclopenten-1-yl)-2-buten-1-ol
2.1% by weight Lyral (4(4-methyl-4-hydroxypentyl)cycloheden-1-carbaldehyde
1.9% by weight isoeugenol (2-methoxy-4-propenylphenol)
0.5% by weight Aldehyde C08 (Octanal)
All weight percentages are based on the complete Perfume oil 11.

### Example 4

### Evaluation of the Development of the Odor Impression with Time

The time development of the odor impression was evaluated over 4 weeks at 25° C. by sniffing by 3 perfumers. Here it turned out that the composition according to the invention, that is, the liquid detergent according to Example 1, with the perfume of Example 2, did not exhibit any change of odor over that period. The comparison composition, i.e., the liquid detergent according to Example 1 with the ordinary detergent perfume from Example 3, however, took on such an unpleasant odor that would be judged no longer suitable, just because of the odor, for laundry washing or for sale.

### Example 5

### Determining the Stability of the Bleaching Agent

The degree of retention of the bleaching agent PAP was evaluated at weekly intervals with storage at 25° C. over a period of 4 weeks for the composition according to the invention, i.e., the liquid detergent according to Example 1 with the perfume from Example 2 (corresponds to “detergent A according to the invention”, and for the comparison composition, i.e., the liquid detergent according to Example 1 with the usual detergent perfume from Example 3 (corresponds to comparison detergent B).

The content of bleaching agent was determined by iodometric titration. The initial concentration (3% absolute) was set at 100%. The concentrations of the bleaching agent (in %) after the various storage times (in weeks) at 25° C. are shown in the following table.

| Storage time | 0 | 1 | 2 | 3 | 4 |
|---|---|---|---|---|---|
| Detergent A (according to the invention) | 100 | 99 | 96 | 93 | 89 |
| Comparison detergent B | 100 | 90 | 75 | 55 | 30 |

The comparison detergent B is seen to have a drastic loss of bleaching agent in the presence of the ordinary perfume of Example 3. With detergent A (according to the invention) containing the perfume according to the invention, unexpectedly good stability is found.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A consumer product comprising an oxidizing agent and a fragrance composition, wherein at least 50% by weight of the fragrance composition comprises one or more fragrances that can be assigned to at least one class of materials selected from the group consisting of saturated alcohols, saturated esters, saturated ethers, aromatics with saturated substituents, nitrites, saturated acetals and saturated hemiacetals.

20. The consumer product of claim 19, wherein the oxidizing agent is an oxidative bleaching agent.

21. The consumer product of claim 20, wherein the oxidative bleaching agent is a peroxycarboxylic acid.

22. The consumer product of claim 21, wherein the peroxycarboxylic acid is selected from the group consisting of mono- and di-peroxycarboxylic acids.

23. The consumer product of claim 21, wherein the peroxycarboxylic acid is selected from the group consisting of dodecane diperoxyacids and imidoperoxycarboxylic acids.

24. The consumer product of claim 21, wherein the peroxycarboxylic acid is 6-phthalimido-peroxycaproic acid (6-phthalimidoperoxyhexanoic acid, PAP).

25. The consumer product of claim 19, wherein the oxidizing agent is essentially in the form of a granule and is coated.

26. The consumer product of claim 19, further comprising at least 0.01% by weight of one or more surfactants.

27. The consumer product of claim 19, further comprising one or more electrolytes.

28. The consumer product of claim 27, wherein the one or more electrolytes is selected from the group consisting of phosphate, citrate and sulfate salts.

29. The consumer product of claim 19, further comprising one or more complexing agents.

30. The consumer product of claim 19, further comprising one or more enzymes.

31. The consumer product of claim 19, further comprising one or more builders selected from the group consisting of fatty acids, citric acid and its salts, polyacrylates and phosphonates.

32. The consumer product of claim 19, further comprising not more than 500 ppm halide ions.

33. The consumer product of claim 19, wherein less than 30% by weight of the total amount of the fragrance in the consumer product is selected from one or more fragrances comprising at least one of an aldehyde group (RCH═O) or a keto group (RR′C═O).

34. The consumer product of claim 19, wherein the consumer product is a liquid.

35. The consumer product of claim 19, wherein the consumer product is a solid.
